(19) United States
(12) Patent Application Publication
(10) Pub. No.: US 2007/0171482 A1
(43) Pub. Date: Jul. 26, 2007

(54) Method and apparatus for managing information, and computer program product

(76) Inventor: Masajiro Iwasaki, Kanagawa (JP)

Correspondence Address: DICKSTEIN SHAPIRO LLP, 1825 EYE STREET NW, Washington, DC, 20006-5403, US

(21) Appl. No.: 11/656,996

(22) Filed: Jan. 24, 2007

(30) Foreign Application Priority Data
Jan. 24, 2006 (JP) 2006-015591
Nov. 28, 2006 (JP) 2006-320792

(51) Int. Cl. H04N 1/387

(52) U.S. Cl. 358/452

(57) ABSTRACT

An area extracting unit extracts area information from a page of document information for each area of different types arranged on the page. A relation extracting unit extracts relation information indicating a relation between the area information and the page of the document information that is an extraction source of the area information, from the page of the document information. A registering unit registers the area information and the relation information in area correspondence information stored in a storage unit in association with each other.

### CROSS-REFERENCE TO RELATED APPLICATIONS

The present document incorporates by reference the entire contents of Japanese priority documents, 2006-015591 filed in Japan on Jan. 24, 2006 and 2006-320792 filed in Japan on Nov. 28, 2006.

### BACKGROUND OF THE INVENTION

1. Field of the Invention

The present invention relates to a technology for managing a plurality of pieces of document information.

2. Description of the Related Art

Document computerization has been advanced recently along with improvements in communication technologies and developments of network environment, thereby promoting paperless systems in offices.

Specifically, a user creates various types of documents on a personal computer (PC) as electronic documents. The created electronic documents are edited, copied, transferred, and shared on the PC or a server. At this time, when the PC or the server storing the documents is connected to other PCs via a network, browsing and editing of the electronic documents can be performed also from the connected PC.

In such an office environment, because several persons create electronic documents on a plurality of PCs, common management of these electronic documents is difficult, which can cause confusion between users. For example, because the user does not know on which PC a necessary electronic document is stored, the user may not be able to find the necessary document. Therefore, some document management systems have been proposed to solve this problem.

For example, in Japanese Patent Application Laid-Open No. H11-120202, scanned document, faxed document, electronic document created by an application, World Wide Web (WWW) document, and the like are stored, with original data being associated with a text file and a thumbnail for each page, for each document. Accordingly, the electronic documents can be collectively managed, irrespective of a difference in a format for each electronic document.

Recently, due to improvements in the computer-related technology, not only documents including information held in electronic documents can be transferred, but also various data such as images and videos can be attached to the document.

In the invention described in Japanese Patent Application Laid-Open No. H11-120202, however, only texts and thumbnails for each page are associated with the original file. When data other than the text such as an image is attached to the electronic document, the data cannot be managed in association with the electronic document. Therefore, its user cannot find the data.

### SUMMARY OF THE INVENTION

It is an object of the present invention to at least partially solve the problems in the conventional technology.

An apparatus for managing information according to one aspect of the present invention includes a storage unit that stores therein area correspondence information in which area information included in an area constituting each page of document information is associated with relation information indicating a relation between the document information, the page, and the area information; an area extracting unit that extracts the area information from the page of the document information for each area of different types arranged on the page; a relation extracting unit that extracts relation information indicating a relation between the area information extracted by the area extracting unit and the page of the document information that is an extraction source of the area information, from the page of the document information; and a registering unit that registers the area information extracted by the area extracting unit and the relation information extracted by the relation extracting unit in the area correspondence information in association with each other.

A method of managing information according to another aspect of the present invention includes area extracting including extracting area information from a page of document information for each area of different types arranged on the page; relation extracting including extracting relation information indicating a relation between the area information extracted at the area extracting and the page of the document information that is an extraction source of the area information, from the page of the document information; and registering the area information extracted at the area extracting and the relation information extracted at the relation extracting in area correspondence information stored in a storage unit in association with each other.

A computer program product according to still another aspect of the present invention includes a computer usable medium having computer-readable program codes embodied in the medium that when executed cause a computer to execute area extracting including extracting area information from a page of document information for each area of different types arranged on the page; relation extracting including extracting relation information indicating a relation between the area information extracted at the area extracting and the page of the document information that is an extraction source of the area information, from the page of the document information; and registering the area information extracted at the area extracting and the relation information extracted at the relation extracting in area correspondence information stored in a storage unit in association with each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWING

FIG. 1 is a block diagram of a configuration of a document management system according to a first embodiment of the present invention;

FIG. 2 is a table structure of a document management table stored in a document meta-database in a document management server according to the first embodiment;

FIG. 3 is a table structure of a page management table stored in the document meta-database in the document management server according to the first embodiment;

FIG. 4 is a table structure of an area management table stored in the document meta-database in the document management server according to the first embodiment;

FIG. 5 is a schematic for explaining an example of a page included in document data to be managed by the document management server according to the first embodiment;

FIG. 6 is a schematic for explaining an example of a screen, in which a document image displayed on a display of a PC is searched;

FIG. 7 is a schematic for explaining an example of a screen, in which a hypertext markup language (HTML) file generated by a search-result generating unit is displayed on the display of the PC;

FIG. 8 is a schematic for explaining an example of a screen in which respective areas indicated as the search result of the document image is displayed in thumbnails;

FIG. 9 is a schematic for explaining an example of a screen in which detailed explanation of the area indicated as the search result is displayed;

FIG. 10 is a schematic for explaining an example of a screen in which the search result of a similar area is displayed on the display of the PC, when a search button is pressed in the screen shown in FIG. 8;

FIG. 11 is a schematic for explaining an example of a screen when “tree” is selected as a display format of the search result of a similar page;

FIG. 12 is a schematic for explaining an example of a screen when a button for moving to the right and displaying an area is pressed in the screen shown in FIG. 11;

FIG. 13 is a schematic for explaining an example of a screen when the search result of the similar page is displayed as a time-series tree structure;

FIG. 14 is a flowchart of a process procedure from reception of the document image to registration of the document image in the document management server according to the first embodiment;

FIG. 15 is a flowchart of a process procedure from a search request of a page in the document image from the PC to display of the search result performed by the document management system according to the first embodiment;

FIG. 16 is a flowchart of a process procedure from a search request of an area in the document image from the PC to display of the search result performed by the document management system according to the first embodiment;

FIG. 17 is a flowchart of a process procedure from a search of an area, an area similar to a page, or a page displayed on the display of the PC to display of the search result in the document management system according to the first embodiment;

FIG. 18 is a block diagram of a configuration of a document management system according to a second embodiment of the present invention;

FIG. 19 is a table structure of an area management table stored in a document meta-database in a document management server according to the second embodiment;

FIG. 20 is a schematic for explaining an example of a screen in which an HTML file generated by a search-result generating unit in the document management server according to the second embodiment is displayed on a display of a PC;

FIG. 21 is a schematic for explaining an example of a screen in which an HTML file generated by the search-result generating unit in the document management server according to a modified example of the second embodiment is displayed on the display of the PC;

FIG. 22 is a block diagram of a configuration of a document management system according to a fourth embodiment of the present invention;

FIG. 23 is a schematic for explaining an example of a screen for searching for a similar page displayed on a display of a PC according to the fourth embodiment;

FIG. 24 is a schematic for explaining an example of a screen for receiving selection of a page in a similar page search displayed by a display processing unit of the PC according to the fourth embodiment;

FIG. 25 is a schematic for explaining an example of a screen for searching for a similar document displayed on the display of the PC according to the fourth embodiment;

FIG. 26 is a flowchart of a process procedure until the document management server according to the fourth embodiment searches a similar document to generate an HTML file in which thumbnails indicating areas similar to a search source area are arranged for each type of search source areas;

FIG. 27 is a schematic for explaining an example of a screen in which an HTML file generated as a result of the similar page search by the search-result generating unit in the document management server according to the fourth embodiment is displayed on the display of the PC;

FIG. 28 is a flowchart of a process procedure until the document management server according to the fourth embodiment searches a similar document to generate an HTML file in which thumbnails of pages similar to a search source page are arranged;

FIG. 29 is a schematic for explaining a concept when a similarity-information searching unit in the document management server according to the fourth embodiment calculates similarity;

FIG. 30 is a schematic for explaining an example of a screen in which an HTML file generated as a result of the similar page search by the search-result generating unit in the document management server according to the fourth embodiment is displayed on the display of the PC;

FIG. 31 is a flowchart of a process procedure until the document management server according to the fourth embodiment searches a similar document to generate an HTML file in which thumbnails of pages included in the document similar to a search source document are arranged;

FIG. 32A is a schematic for explaining a tree generated by recursively searching for a similar area at the time of searching for the similar area, as another example of a modified example 1, when a search condition of creation/update date is not set;

FIG. 32B is a schematic for explaining a tree generated by recursively searching for a similar area at the time of searching for a similar area in the modified example 1, when a predetermined setting is made as the search condition for the creation/update date;

FIG. 33 is a schematic for explaining a tree generated by recursively searching for similar areas at the time of searching for a similar area in a modified example 2; and

FIG. 34 is a hardware configuration of a PC executing a program for realizing functions of the document management server.

### DETAILED DESCRIPTION OF THE PREFERRED EMBODIMENTS

Exemplary embodiments of the present invention will be explained in detail below with reference to the accompanying drawings.

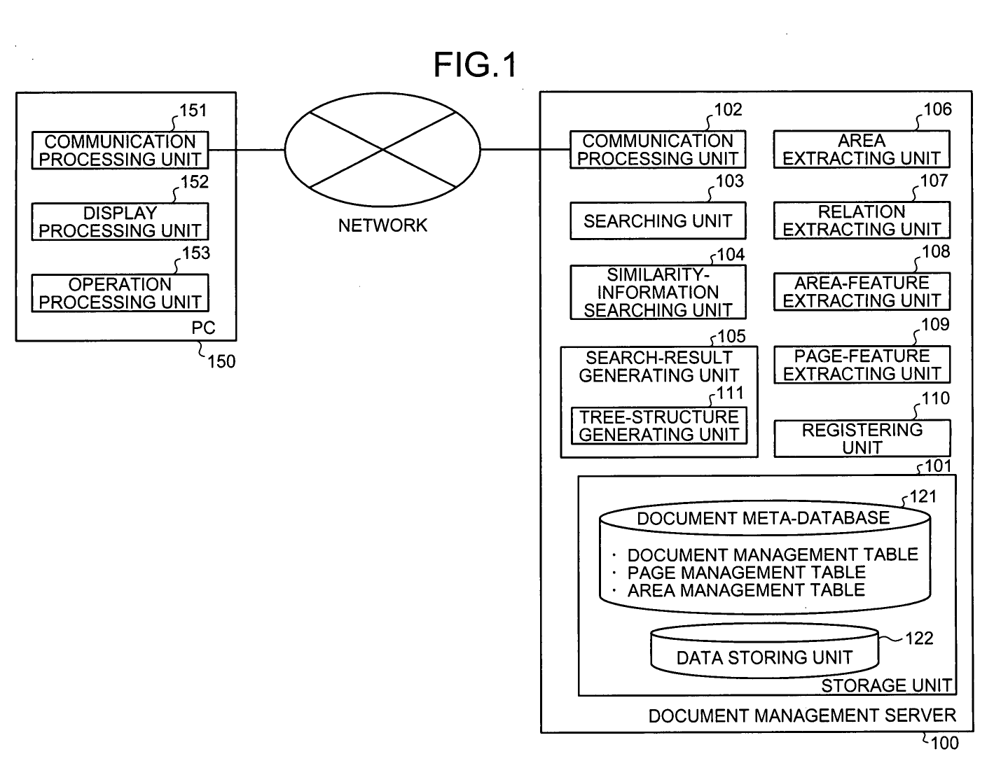

FIG. 1 is a block diagram of a document management system according to a first embodiment of the present invention. In the document management system according to the first embodiment, a document management server 100 and a PC 150 are connected with each other via a network. According to this configuration, the document management server 100 can register document data transmitted from the PC 150 or the PC 150 can search the document management server 100 for the document data. The network used for the document management system can be any network, regardless of being wired or wireless, or a local area network (LAN) or a public communication network.

It is assumed here that the document data managed by the document management system according to the first embodiment includes a document image in which a character and the like are indicated as an image and an electronic document created by a document creation application. However, in processing described below, a case of document image is mainly explained. The document image can be a multiple format capable of holding a plurality of pages or a single page.

These document images include a scanned document read by a scanner, a FAX document received by a facsimile, and the like other than the document images created by users. The document images managed by the document management server 100 can be in any format. Further, a format example that can be held in the multi-page format includes TIFF and the like. The electronic document includes a WWW document and the like created in the HTML.

The PC 150 shown in FIG. 1 includes a communication processing unit 151, a display processing unit 152, and an operation processing unit 153.

The communication processing unit 151 performs processing such as transfer data or the like between another apparatus such as the document management server 100 connected via the network and the PC 150.

The display processing unit 152 displays, for example, document data on a monitor (not shown). The display processing unit 152 displays a screen for searching for document data and a search result screen. The display processing unit 152 uses a Web browser for displaying these screens. These screens can be acquired by communication between the communication processing unit 151 and the document management server 100.

The operation processing unit 153 processes an operation input from a user. As a result, a search condition can be set on the search screen displayed on the Web browser.

The document management server 100 includes a storage unit 101, a communication processing unit 102, a searching unit 103, a similarity-information searching unit 104, a search-result generating unit 105, an area extracting unit 106, a relation extracting unit 107, an area-feature extracting unit 108, a page-feature extracting unit 109, and a registering unit 110, so that the document data can be registered, managed, and searched.

The document management server 100 extracts an area relative to the respective pages of the document data to be managed, and stores a document image, the page, and the extracted area in association with each other. The document management server 100 searches an area or a page included in the document upon reception of a request from the PC 150 or the like, and transmits the search result to the PC 150 or the like.

The storage unit 101 includes a document meta-database 121 and a data storing unit 122. The storage unit 101 can be formed of any generally used storage unit such as a hard disk drive (HDD), an optical disk, a memory card, or a random access memory (RAM).

The document meta-database 121 includes a document management table, a page management table, and an area management table.

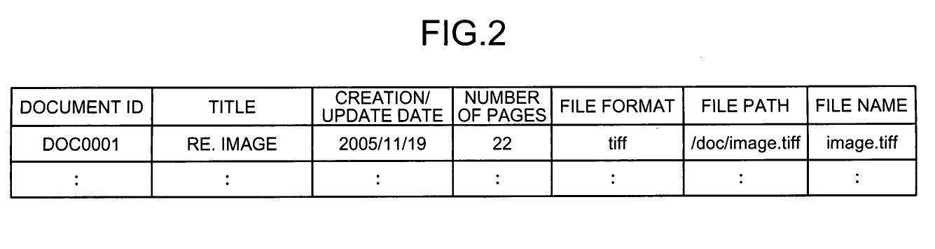

FIG. 2 is a table structure of the document management table. As shown in FIG. 2, the document management table holds a document ID, a title, a creation/update date, the number of pages, a file format, a file path, and a file name in association with each other. According to the first embodiment, these pieces of information are referred to as document meta-information indicating an attribute or the like.

The document ID is a unique ID imparted to each document data, thereby enabling to specify the document data. The title is a title of the document data. The creation/update date holds a creation date or the last update date of the document data. The number of pages holds the number of pages of the document data. The file format holds a format of each document data. As a result, it can be specified in which format the managed document is, among the scanned document, the FAX document, an electronic document created by the application, and the WWW document.

The file path indicates a place where the document data is stored. The file name indicates a file name of the document data.

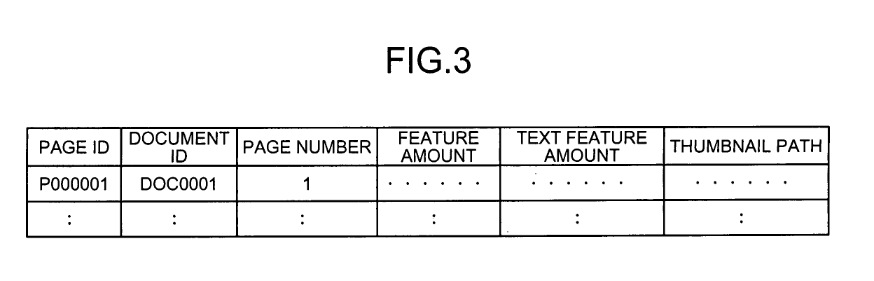

FIG. 3 is a table structure of the page management table. As shown in FIG. 3, the page management table holds a page ID, a document ID, a page number, feature amount, text feature amount, and a thumbnail path in association with each other. According to the first embodiment, these pieces of information are referred to as page meta-information.

The page ID is a unique ID imparted to each page constituting the document data so that the page of the document page managed by the document management server 100 can be uniquely specified by the ID. The document ID specifies the document data including the page. The page number is a page number in the document data including the page. The feature amount indicates a feature extracted from the image, by assuming the entire page as an image.

The text feature amount is a feature extracted from the text information included in the page, and for example, holds a keyword, frequency, and the like in the text information. When the document data is a document image, the text feature amount is extracted from the text information extracted from the document image of the page by using an optical character reader (OCR). The thumbnail path holds a place where a thumbnail indicating the entire image is stored.

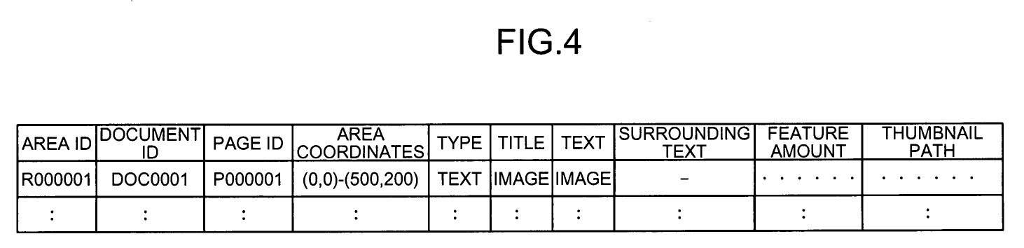

FIG. 4 is a table structure of the area management table. As shown in FIG. 4, the area management table holds an area ID, a document ID, a page ID, area coordinates, a type, a title, a text, a surrounding text, feature amount, and a thumbnail path in association with each other. According to the first embodiment, these pieces of information are referred to as area meta-information.

The area ID is a unique ID imparted to each area extracted from the document data, so that an area included in the document page managed by the document management server 100 can be uniquely specified by the ID. The document ID and the page ID specify the document data and the page including the area. The area coordinates holds coordinates specifying the area, and according to the first embodiment, the area is specified by holding upper left apex coordinates and lower right apex coordinates.

The type holds information for specifying the type of the area data. The data type includes, for example, text, image, and video. According to the first embodiment, the image is further classified into a diagram, a table, and a photograph. According to the first embodiment, however, the data type is not limited thereto, and can be classified by using other types. The title holds a title indicating the area. The text holds text information included in the area.

The surrounding text holds text information arranged in the periphery of the image, when the data type indicates image. Accordingly, the user can set a search condition in text from the search screen, to search a relevant image.

The feature amount holds a feature amount for specifying the area. In the feature amount, for example, when the type is image, the feature amount of the image is stored, and when the type is text, the feature amount of the text is stored. Thus, the feature amount holds a feature amount of a different type according to the type. Accordingly, by comparing the feature amount of the same type, it can be appropriately determined whether the respective areas are similar to each other. An extraction method of the feature amount will be described later. The thumbnail path holds a place where a thumbnail expressing the area is stored.

The data storing unit 122 stores document data, data of each area extracted from the document data, and thumbnails indicating the respective pages or areas. It is assumed that the data of each area is, for example, image data, video data, or text data included in the respective pages of the document data.

The communication processing unit 102 transfers data between a device connected via the network such as the PC 150 and the document management server 100. The data to be received by the communication processing unit 102 includes, for example, document data registered from the PC 150, and a search condition at the time of searching for the document data. The data to be transmitted includes, for example, the managed document data, and data of the search screen or a screen indicating the search result.

The registering unit 110 registers document data to be registered after being received by the communication processing unit 102. The registering unit 110 stores the received document data in the data storing unit 122 in the storage unit 101. The registering unit 110 also stores the meta information of the document data stored in the data storing unit 122 in the document management table in the document meta-database 121. Specifically, the registering unit 110 registers extracted meta information, a file name of the document data, file format indicated by an extension of the file name, and file path of a storage destination of the document data in the document management table in association with a document ID. The document ID is automatically generated at the time of registration.

The registering unit 110 registers not only the document data but also the data in the page management table and the area management table. Registration of respective pages and respective areas will be described later.

The page-feature extracting unit 109 extracts the feature amount from respective pages of the document data received as an object to be managed from the PC 150 or the like. The page-feature extracting unit 109 according to the first embodiment comprehends respective pages as image data to extract the feature amount as an image from the image data. When the document data to be extracted is not a document image but is an electronic document created by the document creation application, the page-feature extracting unit 109 extracts the feature amount after converting the electronic document to image data. As a result, the page-feature extracting unit 109 can extract the feature amount from the respective document data, regardless of the format of the document data. As an extraction method of the feature amount from the image data, any method can be used.

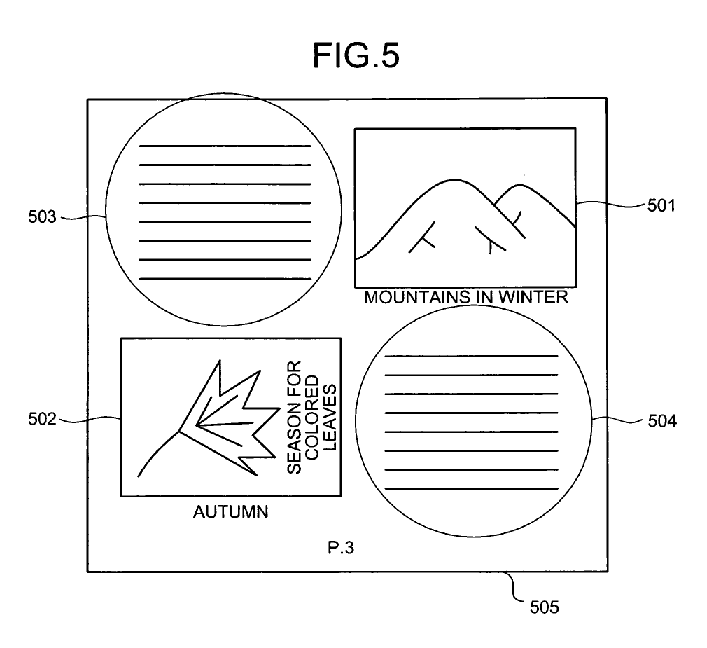

FIG. 5 is a schematic for explaining an example of a page image included in the document data to be managed by the document management server 100. The page image shown in FIG. 5 is formed of two image areas and a document column corresponding to each image. The page-feature extracting unit 109 extracts the feature amount from the page image indicating an entire page 505.

The page-feature extracting unit 109 also extracts a page number and a text feature amount in addition to the feature amount as an image from respective pages. When the document data is a document image, the page-feature extracting unit 109 extracts text information from the page image included in the document image, by using an OCR or the like. The page-feature extracting unit 109 extracts the text feature amount from the extracted text information.

It is assumed that the text feature amount according to the first embodiment is vector (array) data generated as the feature amount from the text included in the page. That is, the page-feature extracting unit 109 performs morphological analysis relative to the text data included in the page to extract a word. The page-feature extracting unit 109 then calculates weighting of the extracted word, thereby to generate vector data indicating how important a keyword is.

As a method for performing weighting of the extracted word, any method can be used, however, according to the first embodiment, weighting calculation is performed by a tf-idf method. The tf-idf method calculates weighting of a word based on a count of the word in the page (it is determined to be important as the number of counts is greater) and based on as to how many pages of the entire managed document data the word appears (it is determined to be important as the number of counts is smaller).

Equation (1) indicates a weighting formula by the tf-idf method.

wi,j=tfi,j×log(N/dfi) (1)

where wi,j denotes weighting of a word in page Di in document data, tfi,j denotes a frequency of the word in the page Di, dfi denotes the number of pages in the entire document data in which the word appears, and N denotes the total number of pages included in the managed document data. Thus, the page-feature extracting unit 109 can extract the text feature amount for each page, according to an array of words and weighting of the words.

The page-feature extracting unit 109 generates a thumbnail indicating the screen. The generated thumbnail is stored in the data storing unit 122.

The meta information extracted by the page-feature extracting unit 109 is registered in the page management table by the registering unit 110. That is, the registering unit 110 registers the page number, feature amount, text feature amount, and storage destination of the thumbnail (thumbnail path) extracted by the page-feature extracting unit 109 in the page management table in association with the page ID and the document ID. The document ID is generated when the document data including the page is registered in the document management table. The page ID is automatically generated at the time of registration in the page management table.

The area extracting unit 106 extracts data indicating an area for each area arranged on the page, from each page in the document data transmitted from the PC 150. For example, if there is an image area in the page, the area extracting unit 106 extracts the image area as the image data. If there is a text area in the page, the area extracting unit 106 extracts the text area as the text data. As an extraction method of the text data, any method can be used, however, a method using, for example, the OCR can be considered. Other areas are also extracted by the same processing. When extracting the text area, the area extracting unit 106 can extract the text area for each column included in the text area.

In the example shown in FIG. 5, the area extracting unit 106 extracts image areas 501 and 502 included in the page from the page. The area extracting unit 106 also extracts text areas 503 and 504. A format of the text areas 503 and 504 can be a text, or can be extracted as image data for holding the configuration of the document.

As an extraction method of the area for each type taken by the area extracting unit 106, any method can be used. For example, when an object is a document image scanned by a scanner, the area extracting unit 106 detects an edge of the image, and specifies a range of a text area or an image area to extract the area for each area. At this time, the area extracting unit 106 specifies the type of each area.

The relation extracting unit 107 extracts a relation between the data of each area extracted by the area extracting unit 106, the document data including the data, and the page of the document data. The relation extracting unit 107 according to the first embodiment extracts a coordinates area on the page of each area, a page ID indicating the page including the data of each area, and the document ID including the page. Accordingly, the data for each extracted area can specify in which position in which page of which document the area is present. In other word, information necessary for generating a tree structure formed of the page and the area included in the document data are extracted.

The area-feature extracting unit 108 extracts the feature amount from the respective areas extracted by the area extracting unit 106. The area-feature extracting unit 108 extracts the feature amount different for each type of the area. For example, when the area to be extracted is an image area, the area-feature extracting unit 108 extracts the feature amount of the image data. When the area to be extracted is a document area, the area-feature extracting unit 108 extracts the text feature amount from the text information included in the area. When the data of the area is video data or audio data, the area-feature extracting unit 108 extracts the feature amount suitable for respective formats. As a result, the feature amount corresponding to the type of each area is registered in the area management table.

When the document data is a document image, the area-feature extracting unit 108 acquires text data in the area by using the OCR, at the time of extracting the feature amount from the text area. Thereafter, the area-feature extracting unit 108 extracts the feature amount from the acquired text data.

If possible, the area-feature extracting unit 108 extracts a title and a text for each extracted area. When the type of the extracted area is an image, the area-feature extracting unit 108 extracts a surrounding text, if possible. As an extraction method of the title, the text, and the surrounding text of the area performed by the area-feature extracting unit 108, any method can be used, however, a method described below is used according to the first embodiment.

When the area is an image, the area-feature extracting unit 108 acquires a text included in the image area or a character string included in a text area surrounding the image as a title.

In the example shown in FIG. 5, the area-feature extracting unit 108 extracts “autumn” in an area below the image area 502 as a title corresponding to the image area 502. If the character string of “autumn” is not in the lower area, the area-feature extracting unit 108 extracts “Season for colored leaves” extracted from the image as the title. If the character string of “Season for colored leaves” is not included in the image area 502, the area-feature extracting unit 108 extracts an appropriate character string from the text area 504 corresponding to the image area 502. As a determination method of the text area corresponding to the image, any method can be used.

When the area is a text, the area-feature extracting unit 108 extracts an appropriate character string as the title by taking the weighting or the like into consideration.

When the area is image data, the area-feature extracting unit 108 extracts character information from the area by the OCR. The area-feature extracting unit 108 assumes the extracted character information as the text of the area. When the area is document data, the document included in the area becomes the text of the area.

In the example shown in FIG. 5, the area-feature extracting unit 108 extracts “Mountains in winter” as the title of the image area 501. The area-feature extracting unit 108 further extracts “Season for colored leaves” as the text of the image area 502.

When the area is an image, the area-feature extracting unit 108 extracts a surrounding text. In the example shown in FIG. 5, the area-feature extracting unit 108 extracts “autumn” or a text in the text area 504 as the surrounding text of the image area 502.

The area-feature extracting unit 108 generates a thumbnail indicating the area. The generated thumbnail is stored in the data storing unit 122.

Thereafter, the registering unit 110 registers the relation extracted by the relation extracting unit 107, the type of each area specified by the area extracting unit 106, and the feature amount extracted by the area-feature extracting unit 108 in the area management table. That is, the registering unit 110 registers the document ID, the page ID, and the area coordinates extracted by the relation extracting unit 107, the type specified by the area extracting unit 106, and the title, the text, the surrounding text, the feature amount, and a thumbnail extracted by the area-feature extracting unit 108 in the area management table in association with the area ID. The area ID is automatically generated at the time of registration in the area management table.

Because the registering unit 110 registers these pieces of information in the area management table, the document management server 100 can manage these pieces of information in a searchable format, irrespective of the type of data for each area included in the document data. At this time, because the registering unit 110 also registers the feature amount, similarity search using the feature amount can be also realized.

The text and the like extracted from the image data are registered by the registering unit 110. Accordingly, because the searching unit 103 can search an area or a page based on the image data by the character string, the user can efficiently detect desired image data.

The searching unit 103 searches the document management table, the page management table, and the area management table in the document meta-database 121 based on a search request of the document data from the PC 150 or the like. Search is explained in detail together with a search screen displayed on a display of the PC 150.

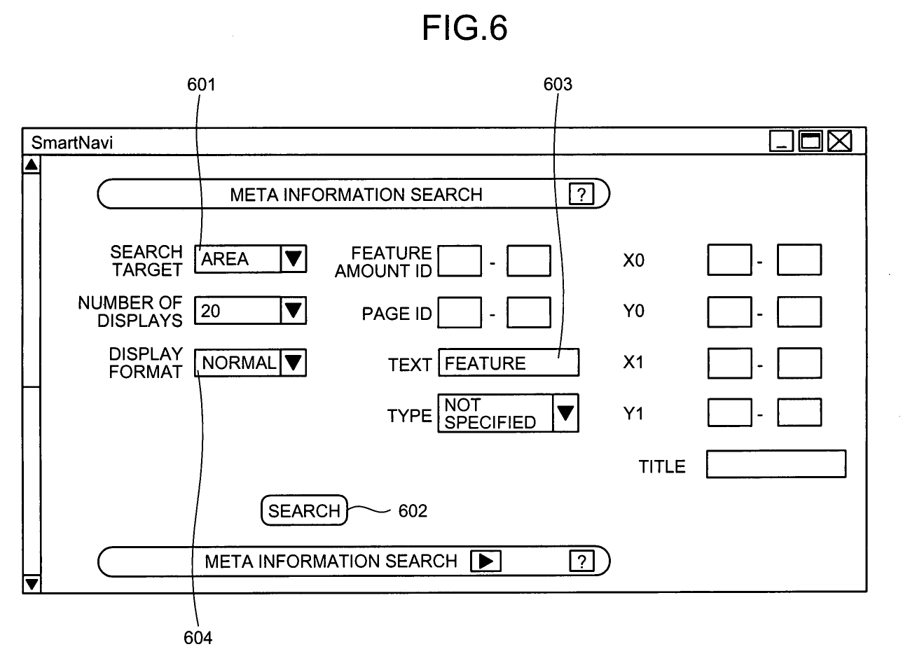

FIG. 6 is a schematic for explaining a screen example, in which a document image displayed on the display of the PC 150 is searched. The search screen is displayed when the user wants to search for a document image by the PC 150. An item for setting the search condition is displayed on the search screen. A search target 601 is an item for the user to select any one of the “document”, “page”, and “area” as a search target. In FIG. 6, it is assumed that the “area” is set the search target. A display format 604 is an item for selecting any one of “normal”, “thumbnail”, and “tree”. In FIG. 6, “normal” format is set. The operation processing unit 153 of the PC 150 sets the search condition relative to the respective items based on an input of the user. When the operation processing unit 153 receives pressing of a search button 602 from the user, the communication processing unit 151 of the PC 150 transmits the set search condition to the document management server 100. In FIG. 6, an example in which “feature” is input in a text 603 as the search condition is shown.

After the communication processing unit 102 in the document management server 100 finishes the reception processing of the search condition from the PC 150, the searching unit 103 searches the corresponding table in the received search condition. Specifically, when “document” is selected in the search target 601 shown in FIG. 6, the searching unit 103 searches the document management table. When “page” is selected, the searching unit 103 searches the page management table. When “area” is selected, the searching unit 103 searches the area management table. The searching unit 103 searches information using the received search condition as a search key. Accordingly, the searching unit 103 can acquire a document image desired by the user, or a page or an area included in the document image. As a result, the information of the area or the page can be efficiently detected in response to a request from the user from the PC 150 or the like.

The search-result generating unit 105 includes a tree-structure generating unit 111 and generates an HTML file indicating the detection result acquired by the searching unit 103 and the search result acquired by the similarity-information searching unit 104 described later. The search-result generating unit 105 also generates an HTML file indicating detailed information of the page or the area. The generated HTML file is transmitted to the PC 150, which has requested the search, by the communication processing unit 102. When the communication processing unit 151 of the PC 150 receives the HTML file, the display processing unit 152 displays the HTML file. Processing of the tree-structure generating unit 111 will be described later.

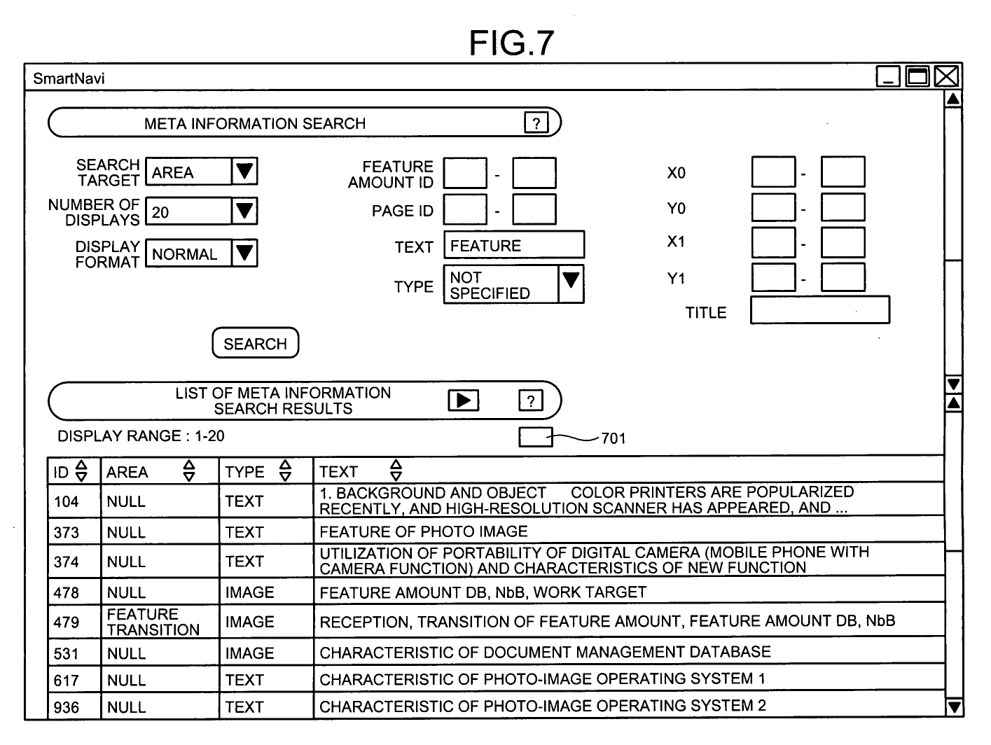

FIG. 7 is a schematic for explaining a screen example, in which the HTML file is displayed on a display of the PC 150. The search result screen is an example of a search result, when “area” is set as the search target and “feature” is set as the text on the search screen shown in FIG. 6. The display format in this case is “normal”. The item to be displayed as the search result can be any item, however, according to the first embodiment, it is assumed that an area ID, an area name (title), a type, and a text are displayed. When the search result screen shown in FIG. 7 is displayed, and when the user clicks the area name, a screen indicating detailed information of the area is displayed. This screen will be described later. When a button 701 is pressed, a result of search for each area performed under the same condition is thumbnail-displayed by the display processing unit 152 of the PC 150. That is, the display format can be easily changed.

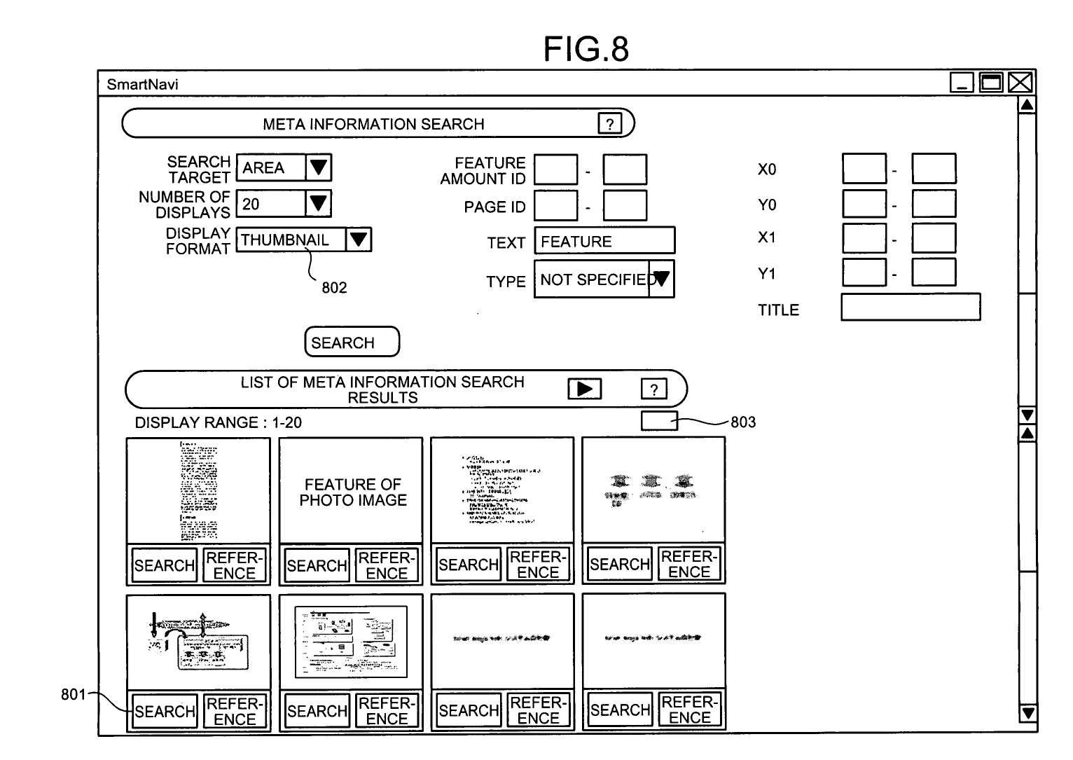

FIG. 8 is a schematic for explaining a screen example in which respective areas indicated as the search result of the document image is thumbnail-displayed, when the button 701 is pressed in the screen example of FIG. 7, or “thumbnail” is selected in the display format in FIG. 6. In the search result screen, “search” button and “reference” button are displayed for each area. When the user presses the “search” button, search of a similar area is performed. When the user presses the “reference” button, detailed information of the area is displayed. When the user presses a button 803, the screen shown in FIG. 7 is displayed again. Thus, in the screen shown in FIG. 8, because the thumbnails are displayed, the user can easily understand the content of each area.

When the button 701 is pressed in the screen shown in FIG. 7, the communication processing unit 151 of the PC 150 transmits a flag indicating display of the search condition and the thumbnails to the document management server 100. The searching unit 103 of the document management server 100 performs search under the received search condition, upon reception of these pieces of information. A different point between the search and the search described above is that field information of the “thumbnail path” is acquired at the time of searching the area management table, based on the flag indicating display of the thumbnails. The search-result generating unit 105 generates an HTML file based on the search result. At that time, the search-result generating unit 105 describes a uniform resource locator (URL) at which the thumbnail generated by the thumbnail path is present for each area. The generated HTML file is transmitted to the PC 150. As a result, the PC 150 can display the search result in which a thumbnail is indicated for each area.

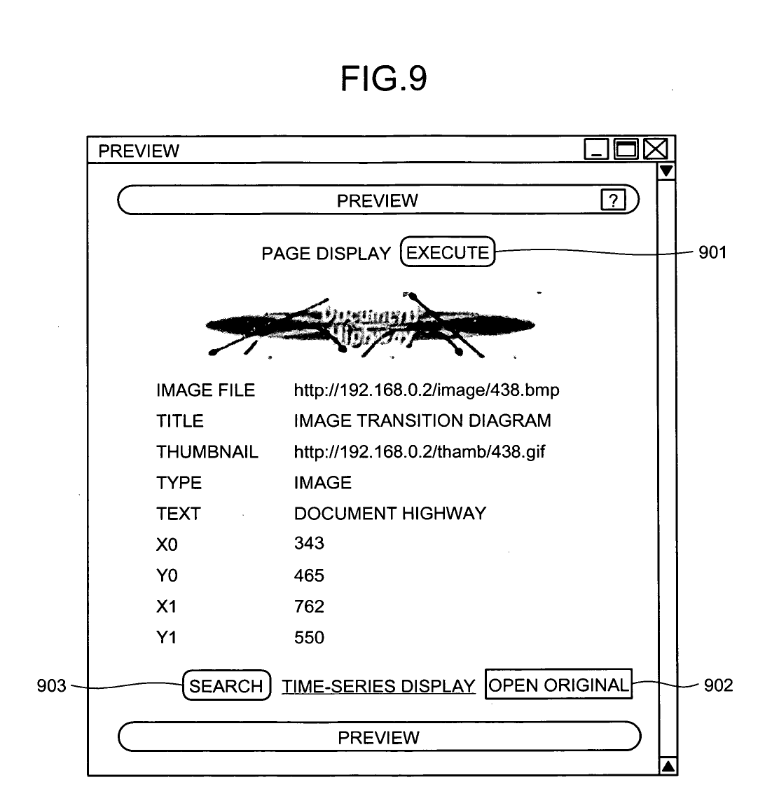

FIG. 9 is a schematic for explaining a screen example in which detailed explanation of the pressed area is displayed when the refer button is pressed in the screen example shown in FIG. 8. In the detailed explanation screen, the meta information of the area held in the area management table of the document management server 100 is displayed. As a result, the user can understand the area.

When the “reference” button is pressed in the screen shown in FIG. 8, the communication processing unit 151 of the PC 150 transmits information indicating that the area ID and details of the area, for which the “reference” button is pressed, are to be displayed to the document management server 100. After the document management server 100 receives these pieces of information, the searching unit 103 of the document management server 100 searches the area management table, using the received area ID as a key. The searching unit 103 then acquires all the field information required for the display of a record agreeing with the search condition. The search-result generating unit 105 generates an HTML file in which the detailed information is described based on the acquired information. The PC 150 then receives the generated HTML file again, thereby displaying the detailed information of the area.

In the detailed display screen of the area shown in FIG. 9, not only the meta information of the area but also the document image or meta information of the page including the area can be displayed. This can be realized because the correspondence between the area, the page, and the document image is held in the area management table.

When the user presses an execute button 901 on the screen shown in FIG. 9, a screen including a thumbnail of the page including the area and meta information of the page is displayed. This can be realized, because association between the area ID and the page ID is held in the area management table in the document management server 100. In other words, after acquiring the page ID of the area, the searching unit 103 searches the page management table, using the page ID as a key, thereby enabling acquisition of information required for the display.

When the user presses an “open the original” button 902 on the screen shown in FIG. 9, document data including the area is displayed. This can be realized, because association between the area ID and the page ID is held in the area management table in the document management server 100. In other words, after acquiring the document ID of the area, the searching unit 103 searches the document management table, using the document ID as a key, thereby enabling acquisition of a path to a storage destination of the document.

Furthermore, by pressing a search button 903, an area similar to the area can be searched for. At this time, the similar area can be also displayed in time series. Details thereof will be described later.

Returning to FIG. 1, the similarity-information searching unit 104 searches an area similar to the area displayed on the display of the PC 150. The similarity-information searching unit 104 also searches a similar page. As the search method of the similar area or page, any method can be used. According to the first embodiment, however, search is performed by using a feature amount held in the area management table of a feature amount held in the page management table. A detailed process procedure of the similar image search will be described later.

The search-result generating unit 105 generates an HTML file based on the search result performed by the similarity-information searching unit 104. The generated HTML file is transmitted to the PC 150 by the communication processing unit 102. As a result, a similar image search result can be displayed on the display of the PC 150.

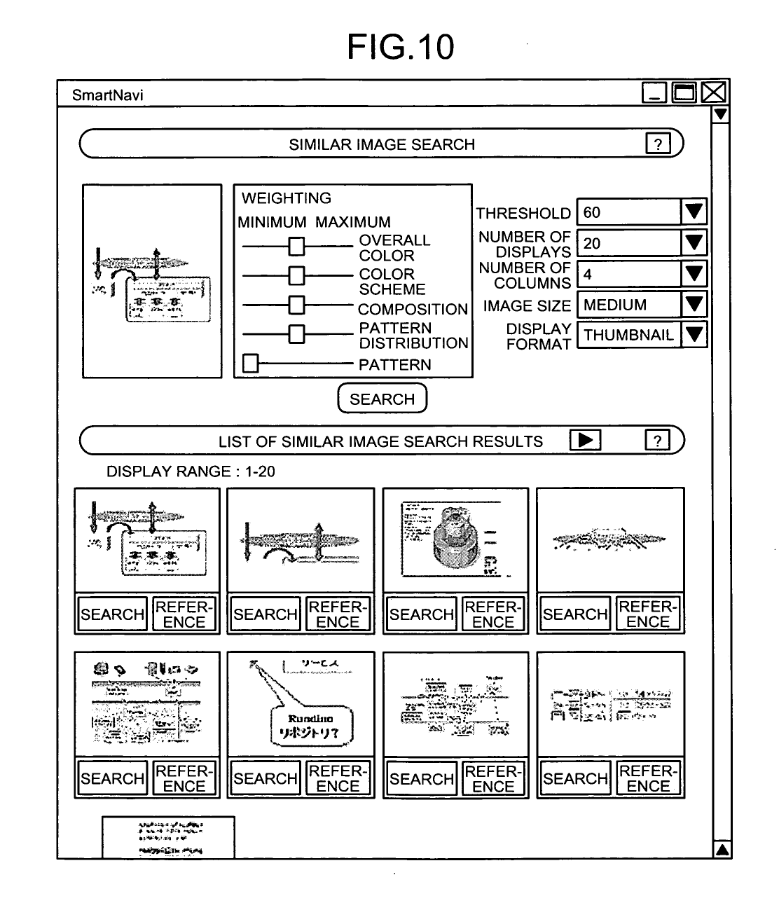

FIG. 10 is a schematic for explaining a screen example of the search result of a similar area displayed on the display of the PC, when a search button 801 is pressed in the screen example shown in FIG. 8. As shown in FIG. 10, an area as a search source is displayed in the upper part of a Web browser, and an area determined to be similar is displayed in the lower part of the Web browser. In the upper part, weighting of the similar image and the display format can be changed. As the display format, “thumbnail” or “tree” can be selected. In FIG. 10, it is assumed that “thumbnail” is selected as the display format.

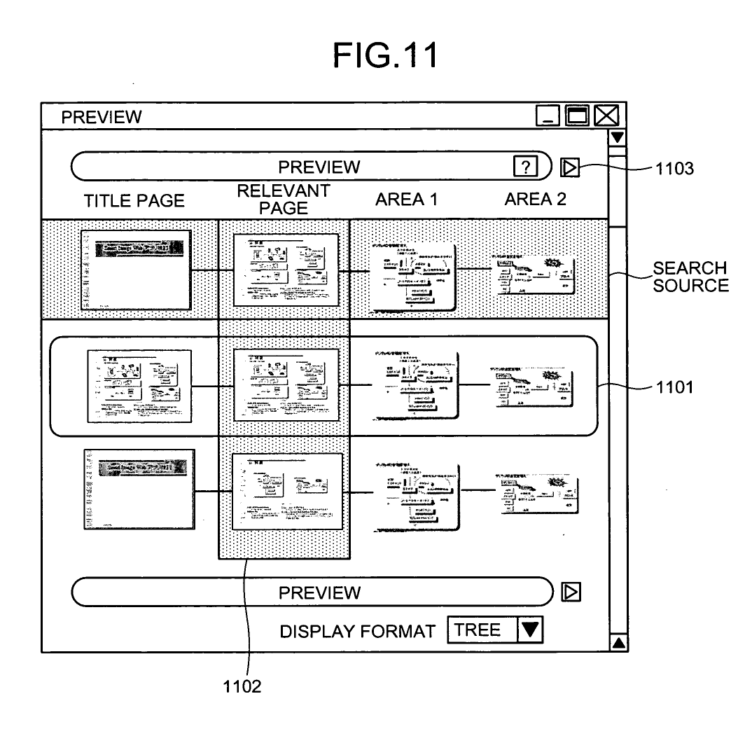

FIG. 11 is a schematic for explaining a screen example when “tree” is selected as the display format of the search result of a similar page. In the example shown in FIG. 11, it is assumed that a similar page is searched. A document image present at the uppermost stage shown in FIG. 11 includes a page as a search source. Document images including a page having the highest similarity to the search source page are shown in a rectangular 1102, with the similarity becoming lower as going downward.

The trees structure included in the HTML file is generated by the tree-structure generating unit 111. That is, after the similarity-information searching unit 104 acquires the search result of the similar page, the tree-structure generating unit 111 searches the document management table and the area management table, using the document ID and the page ID included in the meta information of the acquired similar page as a key, to acquire meta information of the document image including the similar page and the area included in the similar page. The similarity-information searching unit 104 then generates a tree structure by associating the acquired document image, similar page, and area with each other. The page shown in the tree structure and the thumbnails of the areas can be displayed by a thumbnail path held in the meta information. Accordingly, the user can easily understand the document data by the tree structure.

The search-result generating unit 105 generates an HTML file based on the generated tree structure. Accordingly, the search result of the similar page is displayed in a tree structure on the PC 150. The search result of the similar page has been explained with reference to FIG. 11; however, the similar area search can be realized by the same processing. Further, when the user presses a button 1103 shown in FIG. 11, more areas included in respective pages can be displayed.

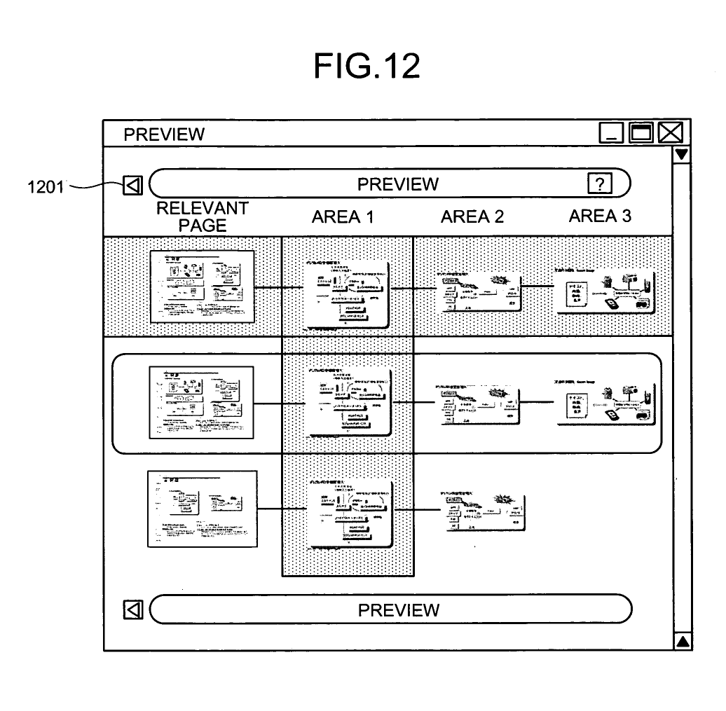

FIG. 12 is a schematic for explaining a screen example when the button 1103 shown in FIG. 11 is pressed. In the screen shown in FIG. 12, three areas are displayed. To display such a screen, any method can be used, for example, search is performed again by the document management server 100. By pressing a button 1201, the screen example shown in FIG. 11 is displayed again.

The search-result generating unit 105 can generate an HTML file in which image data is described in generated or updated time series, based on the search result by the similarity-information searching unit 104. For example, it can be considered that document data including an area similar to the area is displayed in time series, by pressing the search button 903 in the screen shown in FIG. 9.

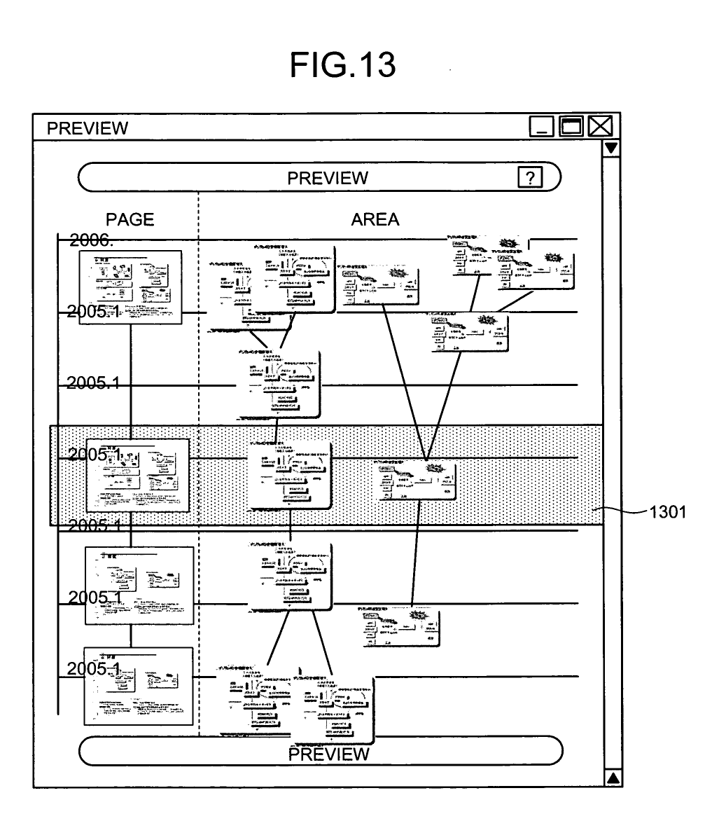

FIG. 13 is a schematic for explaining a screen example when the search result of the similar page is displayed as a time-series tree structure. A range 1301 in the middle of the drawing indicates a search source page and areas included in the page. The page is displayed at the left end, and the included areas are displayed at the right of the displayed page. The page and the areas are displayed, with each similar page and area being linked by a segment individually. The vertical direction in FIG. 13 is a time axis indicating creation date or the last update date.

The similarity-information searching unit 104 in the document management server 100 compares a feature amount of the search source page with a feature amount of respective records stored in the page management table, to calculate the similarity of the pages. When the calculated similarity is higher than a predetermined reference, the similarity-information searching unit 104 determines that the record is similar to the search source page, and acquires a record in which the feature amount used at the time of calculating the similarity is stored as information of a similar page. Further, a similar area can be searched for by performing a similar processing by using the area management table. As the predetermined reference, for example, when the similarity takes a value of from 0 to 1, it can be determined that the page is similar to the search source page when the similarity takes a value of 0.3 or less. Because the similar area is searched according to the same procedure, explanations thereof will be omitted.

The tree-structure generating unit 111 associates a page group and an area group determined to be similar based on the search results with each other in a time-series order. The search-result generating unit 105 then arranges the page group and the area group associated with each other in the time-series order generated by the tree-structure generating unit 111 in a time-series order to generate an HTML file.

There is a case that the same document data is managed for each version, that is, for each update time. In this case, because the document management server according to the first embodiment can realize a display of the document data in time series, the user can confirm the page or area updated with a change of version in the tree structure. As a result, the user can easily recognize an update history in a unit of page or area.

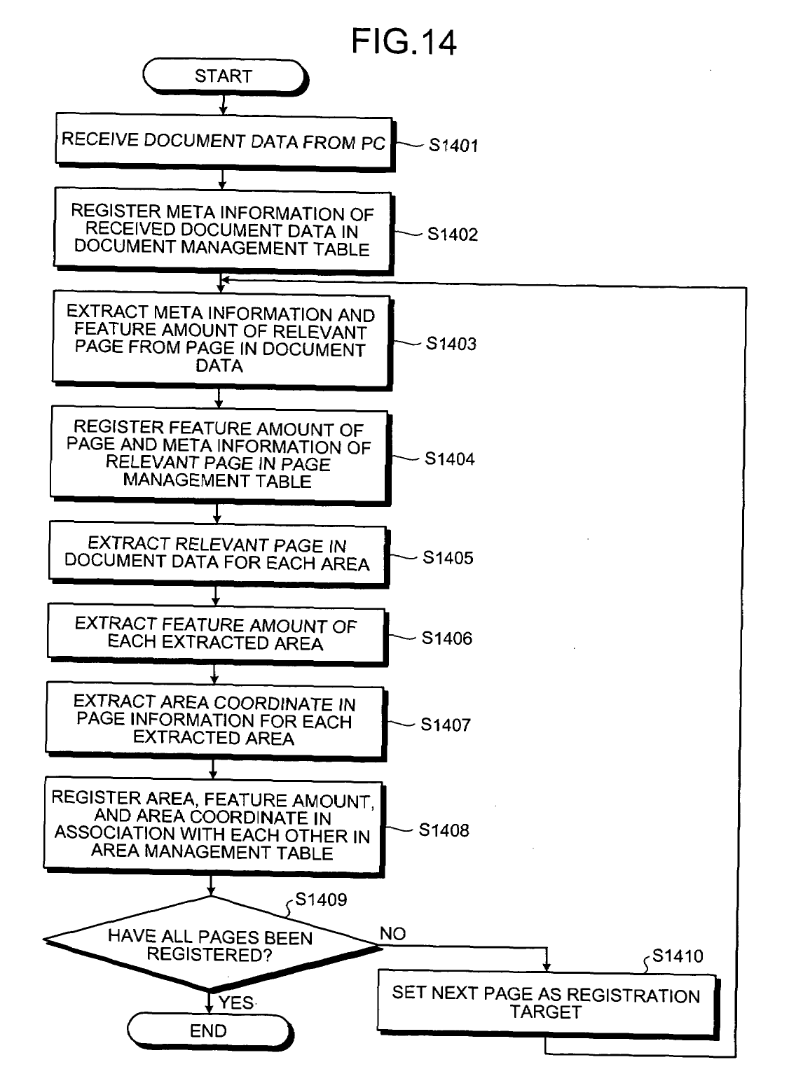

FIG. 14 is a flowchart of a process procedure performed by the document management server 100 according to the first embodiment.

The communication processing unit 102 receives document data to be managed from the PC 150 or the like (step S1401). The registering unit 110 stores the received document data in the data storing unit 122 and extracts the meta information from the document data to register the extracted meta information together with the path in which the document data is stored in the document management table (step S1402).

The page-feature extracting unit 109 extracts the meta information, the feature amount as the page image, and the text feature amount from the page of the registered document data (step S1403). The registering unit 110 then registers the meta information extracted by the page-feature extracting unit 109, the feature amount, and the text feature amount in the page management table (step S1404).

The area extracting unit 106 then extracts the pieces of information for each area from the page of the registered document data based on the type or the like of the data included in the page (step S1405).

The area-feature extracting unit 108 extracts the feature amount for each extracted area (step S1406). The feature amount to be extracted is different according to the type of the data for each area.

The relation extracting unit 107 then extracts a relation between the document data including the area and the page including the area (step S1407). An example of the extracted information includes the document ID, the page ID, and a coordinates area in the page.

The registering unit 110 associates the feature amount extracted by the area-feature extracting unit 108 and the relation extracted by the relation extracting unit 107, and registers the associated feature amount and relation in the area management table (step S1408).

The registering unit 110 determines whether the processing has finished for all the pages (step S1409). When it is determined that the processing has not finished yet (NO at step S1409), the registering unit 110 sets the next page as a registration target (step S1410), so that the extraction processing of the meta information and the feature amount from the page is performed by the page-feature extracting unit 109 (step S1403).

When it is determined that the processing for all the pages has finished (YES at step S1409), the registering unit 110 finishes the processing.

The document management server 100 can manage the document data, the page and the area included in the document data in another table by performing the processing described above.

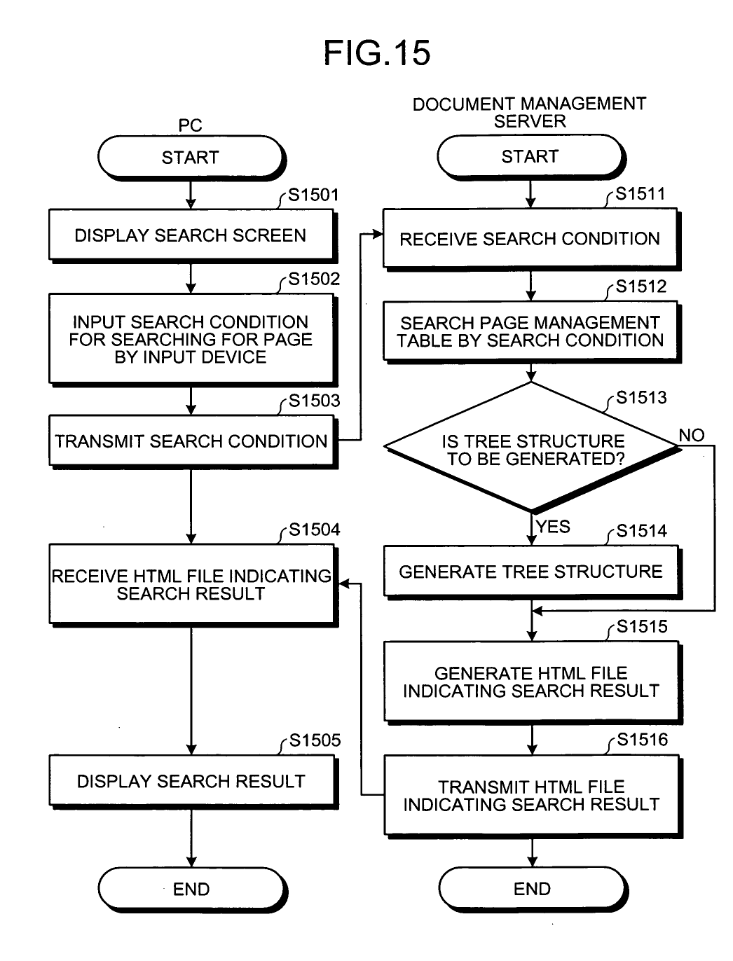

FIG. 15 is a flowchart of a process procedure performed by the document management system according to the first embodiment.

The display processing unit 152 of the PC 150 displays the search screen on the Web browser (step S1501). The operation processing unit 153 inputs a search condition for searching for the page input by the user via the input device (step S1502). The search target 601 is set to “page” in the example shown in FIG. 6, to select the page as the search condition.

The communication processing unit 151 transmits the search condition of the input page to the document management server 100 (step S1503). The communication processing unit 151 also transmits a condition at the time of display (for example, display format, number of displays, or the like), together with the search condition. Accordingly, the document management server performs the search.

The communication processing unit 102 of the document management server 100 receives the search condition of the page and the display condition from the PC 150 (step S1511). The searching unit 103 searches the page management table using the search condition of the received page as a key (step S1512).

The search-result generating unit 105 determines whether to generate the tree structure according to the received display condition, after the search has finished (step S1513). When the search-result generating unit 105 determines not to generate the tree structure (NO at step S1513), the processing by the tree-structure generating unit 111 is not particularly performed. When it is determined to select the tree structure as the display condition, the user sets the display format 604 to the “tree” in the example shown in FIG. 6.

When the search-result generating unit 105 determines to generate the tree structure (YES at step S1513), the tree-structure generating unit 111 generates the tree structure based on the search result (step S1514). A tree generated by the tree-structure generating unit 111 includes a page specifying the document data (for example, the first page), pages satisfying the search condition, and an area included in the page satisfying the search condition, for each of the document data including the page satisfying the search condition.

The above configuration generated by the tree-structure generating unit 111 can be specified by the document ID and the page ID acquired from the search result at step S1512. That is, by setting the document ID and the number of pages=1 to search the page management table, the first page can be acquired. Further, by searching page management table with the page ID as the search condition, the configuration included in the page can be acquired.

The search-result generating unit 105 generates an HTML file indicating the search result by the searching unit 103 (step S1515). When the tree structure is generated by the tree-structure generating unit 111, the search-result generating unit 105 generates the HTML file including the tree structure.

The communication processing unit 102 transmits the generated HTML file to the PC 150 (step S1516).

The communication processing unit 151 of the PC 150 receives the HTML file, in which the search result is described, from the document management server 100 (step S1504). The display processing unit 152 displays the received HTML file on the Web browser (step S1505).

Accordingly, the page included in the document data can be searched for according to the condition set by the user.

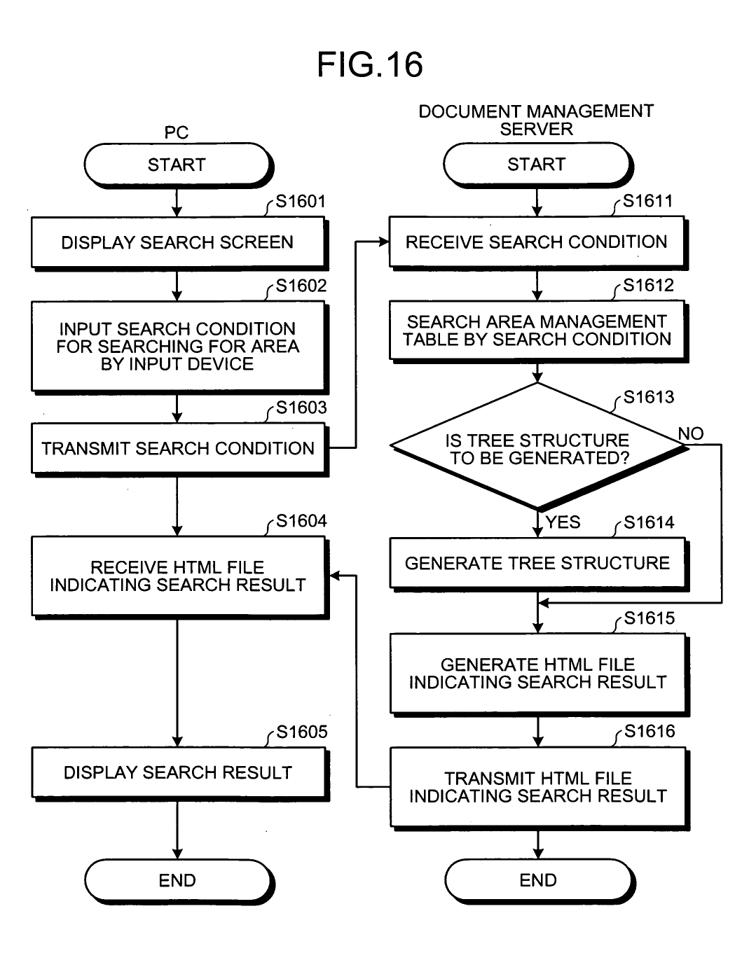

FIG. 16 is a flowchart of a process procedure performed by the document management system according to the first embodiment.

The flowchart for the area search shown in FIG. 16 is substantially the same as that for the page search shown in FIG. 15. As different points, the search condition for searching for the page at step S1502 in FIG. 15 is changed to the search condition for searching for the area at step S1602, and the search of the page management table at step S1512 in FIG. 15 is changed to the search of the area management table at step S1612. Because the document ID and the page ID can be acquired from the search result at step S1612, the configuration of the tree generated at step S1614 can be acquired by the same procedure as in FIG. 15. Because other points are the same as in FIG. 15, explanations thereof will be omitted.

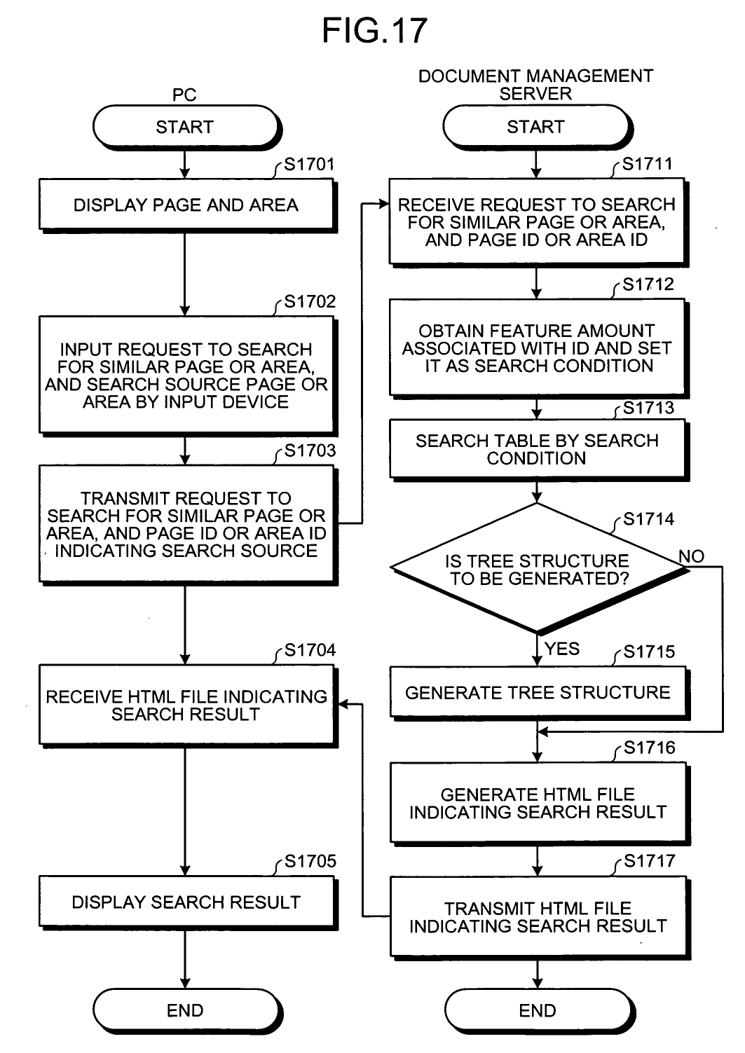

FIG. 17 is a flowchart of a process procedure performed by the document management system according to the first embodiment.

The display processing unit 152 of the PC 150 displays at least one page or area on the Web browser (step S1701). As the displayed screen, for example, a screen shown in FIG. 8, 9, or 10 can be used.

The operation processing unit 153 inputs a page or an area to be a search source selected by the user using the input device, and a request to search for a similar page or area (step S1702). In the example shown in FIG. 8, by pressing “search” button in an optional area, an area as the search source and the request to search for a similar area are set.

The communication processing unit 151 transmits the page ID or the area ID as the search source, and the request to search for a similar page or area to the document management server 100, (step S1703). As a result, the document management server 100 starts search for the similar area or page.

The communication processing unit 102 in the document management server 100 receives the request to search for a similar page or area, and the page ID or the area ID from the PC 150 (step S1711).

Because the request to search for the similar page or area has been received, the similarity-information searching unit 104 acquires the feature amount associated with the received page ID or the area ID, to set the acquired feature amount as the search condition (step S1712). In the case of the area ID, the similarity-information searching unit 104 searches the area management table with the area ID, thereby to acquire the associated feature amount. The feature amount associated with the page ID can be also acquired from the page management table. While an example using the area ID is taken here for a simple explanation, an example using the page ID can be also taken in the similar processing.

As a method for setting the acquired feature amount as the search condition, any method can be used. Weighting to the parameter can be changed at the time of setting the feature amount as the search condition. As an example for changing the weighting, weighting can be changed in the screen example shown in FIG. 10. As a method for changing the weighting to perform a search, any method can be used, irrespective of known methods.

The similarity-information searching unit 104 searches for the similar area or page according to the set search condition (step S1713). The similarity-information searching unit 104 calculates the similarity from the feature amount in the search condition and the feature amount in the respective records, to acquire the similar area or page based on the similarity.

When search has finished, the search-result generating unit 105 determines whether to generate the tree structure according to the received display condition (step S1714). When the search-result generating unit 105 determines not to generate the tree structure (NO at step S1714), the processing of the tree-structure generating unit 111 is not particularly performed. As an example of generating the tree, a case that search is performed by “time-series display” in the screen example shown in FIG. 9 can be mentioned.

When the search-result generating unit 105 determines to generate the tree structure (YES at step S1714), the tree-structure generating unit 111 generates a tree structure based on the search result (step S1715). The configuration included in the tree generated by the tree-structure generating unit 111 can be either the tree for each document data shown in FIG. 11 or the tree associated according to the time series shown in FIG. 13.

The search-result generating unit 105 generates an HTML file indicating the search result by the similarity-information searching unit 104 (step S1716). When the tree structure has been generated by the tree-structure generating unit 111, the search-result generating unit 105 generates the HTML file including the tree structure.

The communication processing unit 102 transmits the generated HTML file to the PC 150 (step S1717).

The communication processing unit 151 of the PC 150 receives the HTML file describing the search result from the document management server 100 (step S1704). The display processing unit 152 displays the received HTML file on the Web browser (step S1705).

As a result, the document management system according to the first embodiment can search for the similar page or area.

According to the first embodiment, information is stored in each table in the relational database for each document data, page, and area. However, the information holding method is not limited to such a format, and for example, the meta information of the document data can be described in the XML and stored in an XML database.

According to the first embodiment, a system including the PC 150 operated by the user and the document management server 100 that performs document management and search has been explained. According to this configuration, document management and search can be realized by a generally used client server system.

Furthermore, the functions of the PC 150 and the document management server 100 can be realized by a stand alone configuration, not by the configuration including a plurality of apparatuses as according to the first embodiment.

In the document management server according to the first embodiment, search by a unit of area or page can be performed and desired information can be easily acquired, even when huge document data is managed.

When an image or the like included in the document data is searched for, an area or a page similar to the image or the like can be searched for by using a feature amount corresponding to the image or the like. When a similar area or page is to be searched for, search can be performed by combining a plurality of different conditions such as meta information in addition to the feature amount.

When the search result is output, because an HTML file in which a tree including the page and the area is described can be generated, the user can easily understand the relation between the page and the area.

According to the first embodiment, the thumbnail is prepared as the image for each page. However, according to the first embodiment, when a page is displayed, the display is not limited to one image such as the thumbnail. Therefore, as a second embodiment of the present invention, a case that areas are combined to display a page is explained.

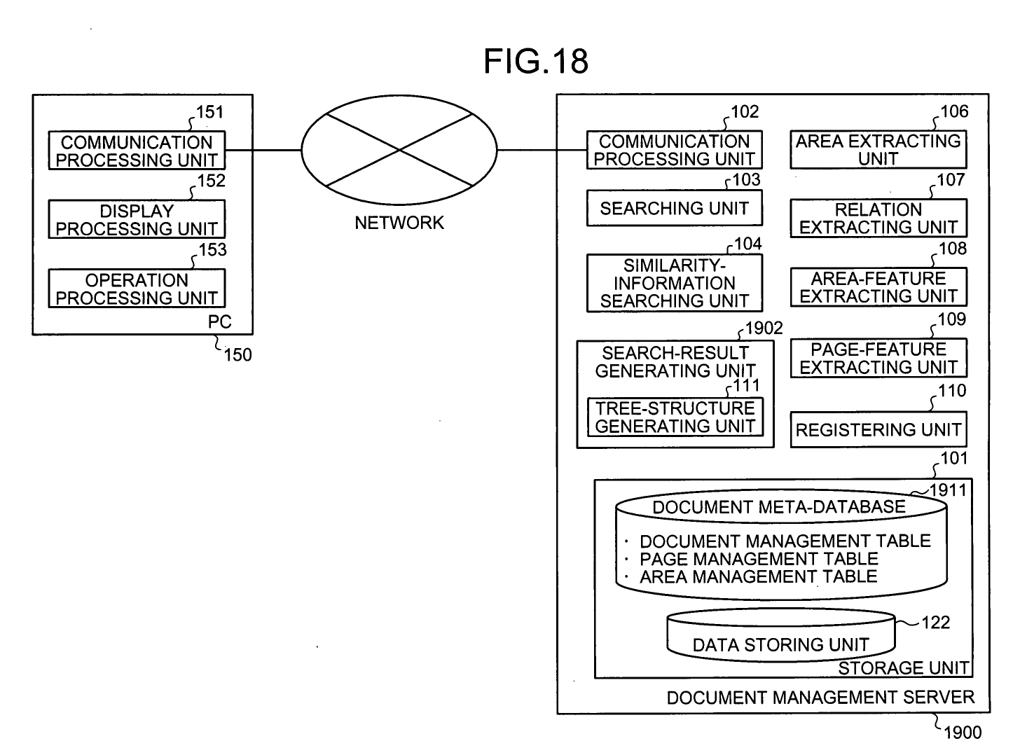

FIG. 18 is a block diagram of a configuration of the document management system according to the second embodiment. A document management server 1900 according to the second embodiment is different from the document management server 100 according to the first embodiment in that the search-result generating unit 105 is changed to a search-result generating unit 1902 having different processing, and the document meta-database 121 is changed to a document meta-database 1911 in which different tables are stored. Like reference numerals refer to like parts or elements throughout, and explanations thereof will be omitted.

The page management table and the area management table in the document meta-database 1911 of the storage unit 101 are different from those according to the first embodiment in that the area management table has a different field configuration and the page management table has the same field configuration except that a field of the thumbnail path is deleted.

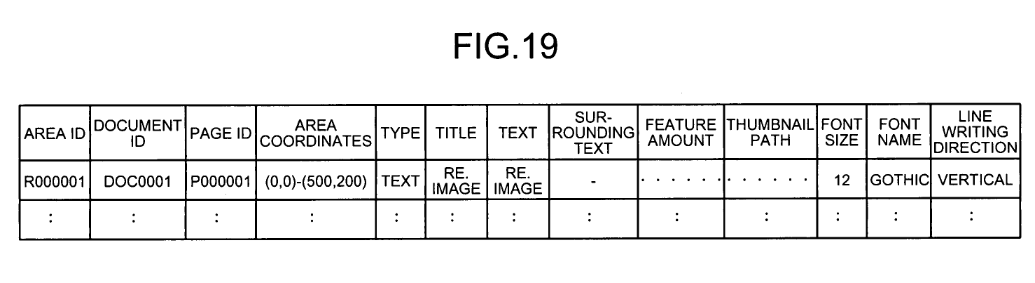

FIG. 19 is a table structure of the area management table. As shown in FIG. 19, the area management table holds a font size, a font name, and a line writing direction in addition to the fields in the area management table according to the first embodiment in association with each other. The configuration of the text area can be reproduced substantially the same as the original document by holding the font size, the font name, and the line writing direction.

As a point different from the search-result generating unit 105 according to the first embodiment, the search-result generating unit 1902 combines the search result including the page or the detailed display of the page with the area included in the page to generate the search result. Because the other points are the same as that of the search-result generating unit 105, explanations thereof will be omitted.

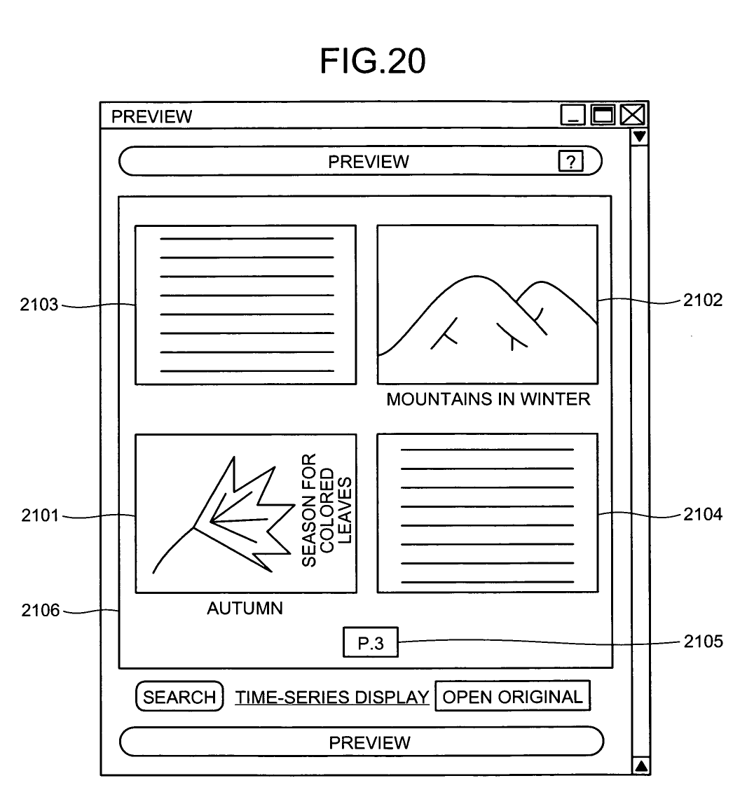

FIG. 20 is a schematic for explaining a screen example in which an HTML file generated by the search-result generating unit 1902 is displayed on the display of the PC 150. As shown in FIG. 20, a page 2106 is realized by combining an image 2101, an image 2102, a text area 2103, a text area 2104, and a text area 2105 with each other. The search-result generating unit 105 generates the HTML file in which these areas are arranged in the page 2106 according to the area coordinates held by the area management table. In the case of the text area, the search-result generating unit 105 arranges a text in an area secured according to the area coordinates, according to the font size, the font name, and the line writing direction in the area management table. As a result, the search-result generating unit 105 can realize the original page layout. Although not shown, display can be performed by surrounding each area by a thick frame or the like, thereby improving visibility of each area.

Accordingly, because image data such as thumbnails need not be held for each page, the data amount stored in the storage unit 101 can be reduced.

The present invention is not limited to the above embodiments, and various modifications are possibly made. For example, according to the second embodiment, a text is arranged in the text area. However, image data extracted from the text area of the page can be arranged therein. Therefore, as a modified example of the second embodiment, an example in which images are combined and displayed at the time of displaying the page, regardless whether the area is the text area or not, will be explained. Other configurations and processing are the same as those according to the second embodiment, and explanations thereof will be omitted.

The area extracting unit 106 extracts the image data for each area from the respective pages of the document image. When the document data is data other than the document image, processing explained in a third embodiment of the present invention is performed. The area extracting unit 106 corrects the extracted image data. For example, image correction is performed to increase the contrast and chroma. As a result, the image data having a color close to a digital document is created.

The search-result generating unit 1902 in the modified example is different from the search-result generating unit 1902 according to the second embodiment in that at the time of generating an HTML file for displaying the search result including the page or details of the page, only images extracted from respective areas are combined to generate the HTML file, regardless whether each area in the page is the test area or not. When arranging a text image in the text area of the HTML file, the search-result generating unit 1902 in the modified example embeds text information extracted from the text area as an attribute of the text image.

Accordingly, when the PC 150 displays the HTML file, and the user indicates the text area by a pointing device, the text information embedded in the text area can be displayed in a pop-up window.

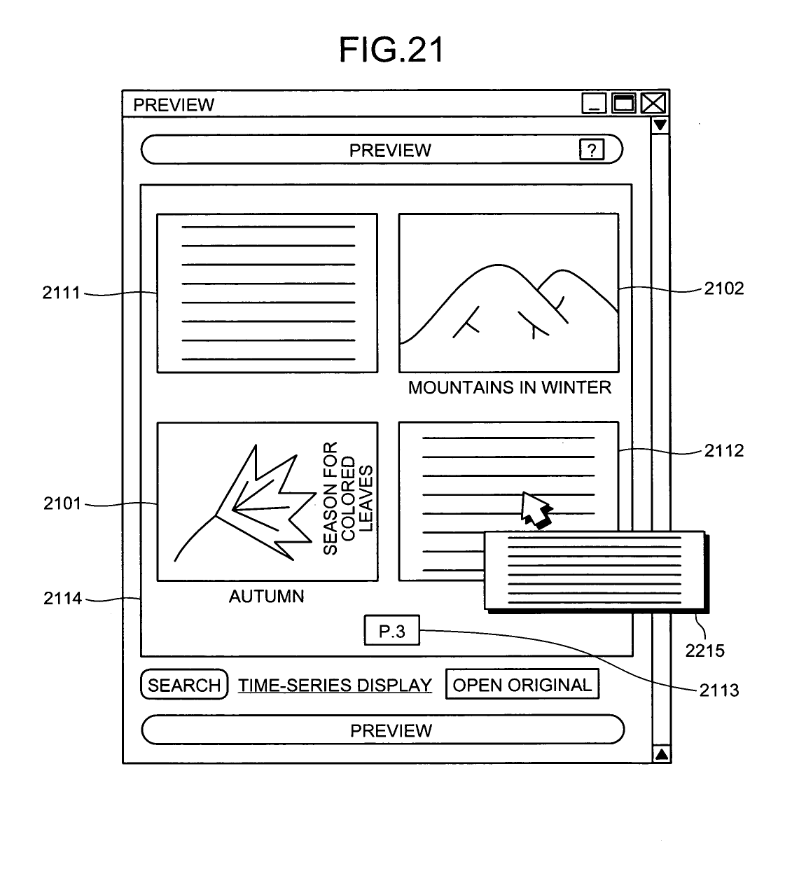

FIG. 21 is a schematic for explaining a screen example in which an HTML file generated by the search-result generating unit 1902 is displayed on the display of the PC. As shown in FIG. 21, a page 2114 is realized by combining the image 2101, the image 2102, a text area 2111, a text area 2112, and a text area 2113 with each other. When a text image expressing a document, for example, the text area 2112 is indicated by the pointing device, the PC 150 displays text information embedded as an attribute of the image in a pop-up window. In a pop-up display 2215, the embedded text information is displayed by using font data. As a result, visibility is improved than in a case of referring to an image including a character string. Accordingly, the user can easily understand the content of the document.

According to the second embodiment, when the user indicates a text area by the pointing device, the PC 150 displays a document included in the text area by using a character code in a pop-up window. However, text display is not limited to such a method, and any method can be used, so long as a text included in the text area is displayed by using the font data at the time of displaying the image in the text area. For example, when selection of an image in the text area is received from the user, the PC 150 requests the document management server 1900 to transmit text information included in the text area. After the document management server 1900 transmits the text information to the PC 150, the PC 150 can display the received text information in another window or the like by using the font data.

According to the first and the second embodiments, an example in which a document image is used as the document data has been mainly explained. According to the third embodiment, therefore, an example in which document data other than the document image is processed is explained. The configuration of the document management server according to the third embodiment is the same as that of the document management server according to the first embodiment, and explanations thereof will be omitted.

As the document data managed by the document management server according to the third embodiment, for example, an electronic document created by the document creation application can be used. The electronic document used according to the third embodiment is not limited to an electronic document created by the document creation application, and any data including text information by a character code (for example, JIS code and Unicode) can be used.

When the document data transmitted from the PC 150 is an electronic document, the area extracting unit 106 converts the electronic document to image data for each page, to extract image data indicating an area from the image data for each area. Thus, by converting the electronic document to image data, the subsequent processing can be coordinated with the document image data.

Further, the area extracting unit 106 directly extracts text information from the text area in the electronic document. By directly extracting text information from the electronic document, accuracy can be improved than in a case in which text information is extracted from the image data by the OCR or the like.

Because the document management server according to the third embodiment performs processing after converting each page in the electronic document to image data, coordinated processing and management with the document image data (including scanned paper documents and data received by fax) can be performed.

According to the first embodiment, only a case that the search source is an area in the similarity search has been explained. In a fourth embodiment of the present invention, therefore, a case that the search source in the similarity search is a page or a document is explained.

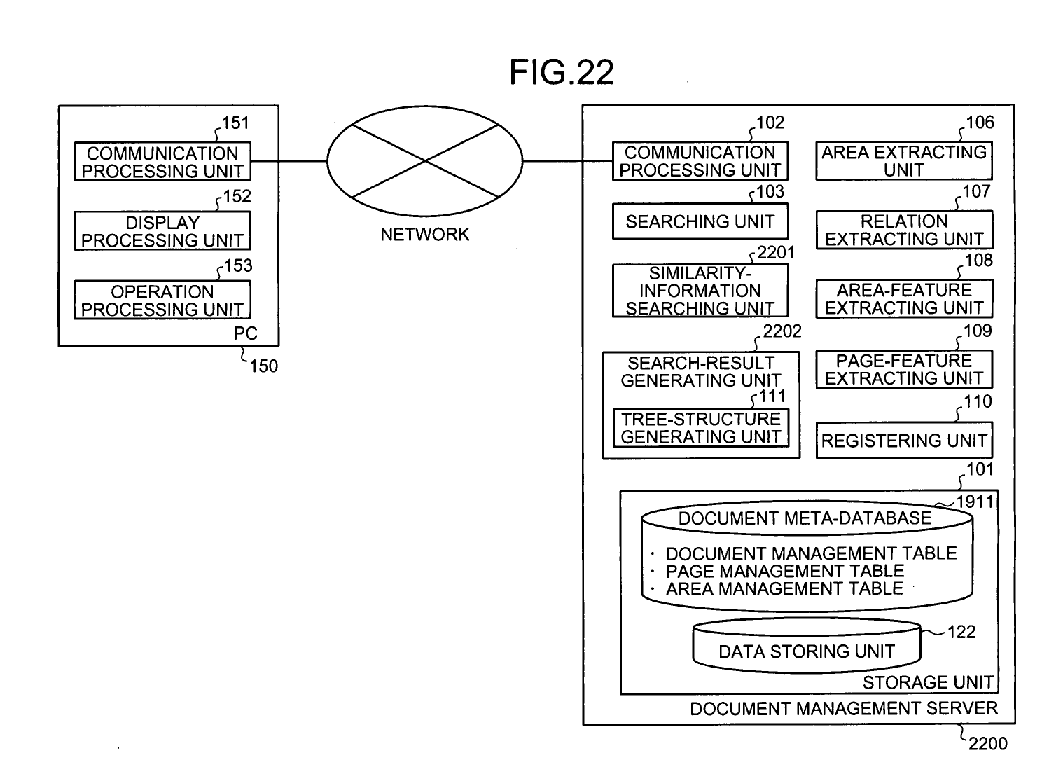

FIG. 22 is a block diagram of a configuration of the document management system according to the fourth embodiment. A document management server 2200 according to the fourth embodiment is different from the document management server 1900 according to the second embodiment in that the similarity-information searching unit 104 is changed to a similarity-information searching unit 2201 having different processing, and the search-result generating unit 1902 is changed to a search-result generating unit 2202 having different processing. In the following explanation, like reference numerals refer to like parts according to the second embodiment, and explanations thereof will be omitted.

The similarity-information searching unit 2201 searches the document management table, the page management table, and the area management table in the document meta-database 121, based on a document data search request from the PC 150 or the like. The similarity-information searching unit 2201 is different from the similarity-information searching unit 104 in that the similarity-information searching unit 2201 can search for a similar page or a similar document.

FIG. 23 is a schematic for explaining a screen example for searching for a similar page displayed on the display of the PC 150. This search screen is displayed when it is desired to search for a similar page on the PC 150. According to the fourth embodiment, search for a similar page means search for a page similar to a page selected as a search target by the user, or a search for an area similar to each area included in the selected page.

As shown in FIG. 23, selection of either a page or an area is received in a “unit of display” 2301. Upon reception of page selection, the document management server 2200 searches for a similar page. Upon reception of area selection, the document management server 2200 searches for an area similar to each area included in the page.

When area selection is received in the “unit of display” 2301, selection of type of the area as a search target is received in a type area 2302 to be displayed, in this search screen. In the search screen according to the fourth embodiment, selection of any one of a text, a diagram, a table, and a photograph is received as the area type. The document management server 2200 searches for a similar area, only for the type of area selected in the type of area 2302 to be displayed.

Further, in the search screen shown in FIG. 23, upon reception of an input of a file name to a search source column 2303 from the user, the operation processing unit 153 of the PC 150 determines a document including the page as a search target.

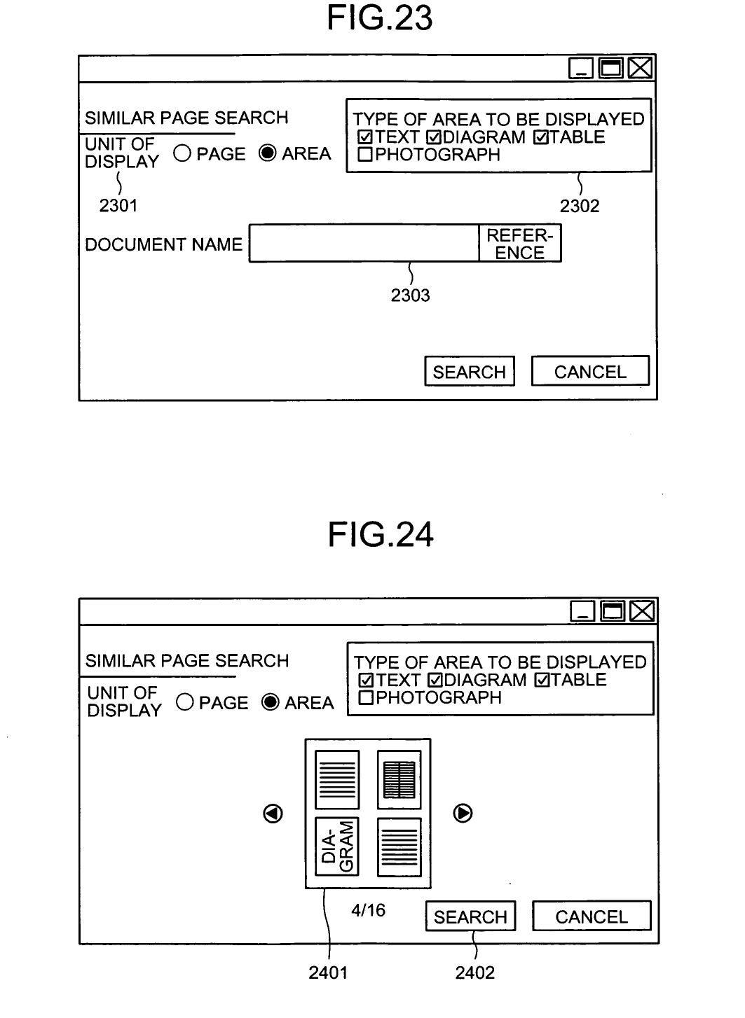

FIG. 24 is a schematic for explaining an example of a screen for receiving selection of a page in a similar page search displayed by the display processing unit 152 of the PC 150. The similar-page search screen shown in FIG. 24 is displayed after a document is determined in FIG. 23. In the similar-page search screen shown in FIG. 24, pages included in the document are displayed as a thumbnail 2401. When the user presses an arrow button in the similar-page search screen, the display processing unit 152 changes the page displayed in the thumbnail 2401. The pages displayed in the thumbnail 2401 become a target of a similarity search. When the operation processing unit 153 receives pressing of a search button 2402 by the user, the communication processing unit 151 transmits information indicating that a similar page is to be searched, and information of the selected “unit of display”, the selected “type of area to be displayed”, and the page displayed in the thumbnail 2401 to the document management server 2200. As a result, the document management server 2200 performs a similar page search. A detailed similar-page search procedure will be described later. Although different from the fourth embodiment, selection of area to be searched from the thumbnail 2401 can be received from the user.

At the time of searching for a similar page, the similarity-information searching unit 2201 calculates the similarity between each area included in the page selected by the user and each area stored in the area management table in the document meta-database 1911. The similarity-information searching unit 2201 then detects an area determined to be similar to the search source page or a page including the area, based on the calculated similarity. A detailed procedure thereof will be described later.

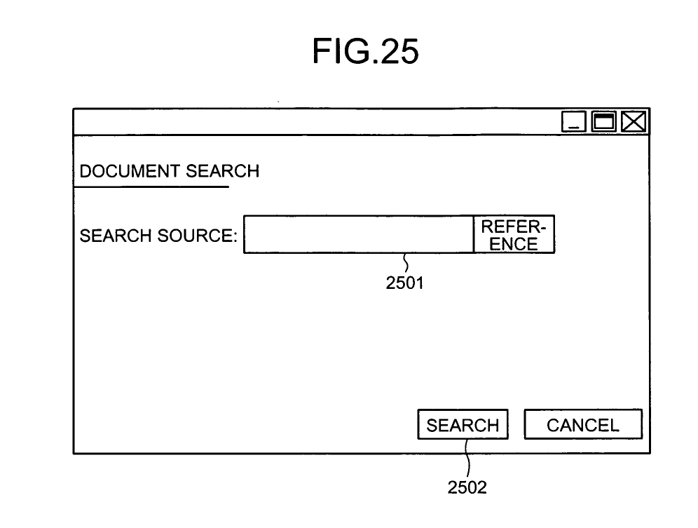

The similarity-information searching unit 2201 also searches a document similar to the document input by the user. FIG. 25 is a schematic for explaining a screen example for searching for a similar document displayed on the display of the PC. A similar document search is for receiving selection of a document to be searched from the user and searching for a document similar to the selected document.

In the search screen shown in FIG. 25, upon reception of an input of a file name to a search source column 2501 from the user, the operation processing unit 153 of the PC 150 determines a document to be searched. When the operation processing unit 153 receives pressing of a search button 2502 from the user, the communication processing unit 151 transmits the information of the selected document together with a request to perform a similar document search to the document management server 2200. As a result, the document management server 2200 performs a similar document search. A detailed similar-document search procedure will be described later.

The search-result generating unit 2202 generates an HTML file indicating the search result performed by the searching unit 103 and the search result performed by the similarity-information searching unit 2201. Further, the search-result generating unit 2202 is different from the search-result generating unit 105 according to the second embodiment in that the search-result generating unit 2202 generates an HTML file indicating the search result of a similar page and the search result of a similar document. An example of the HTML file will be described later.

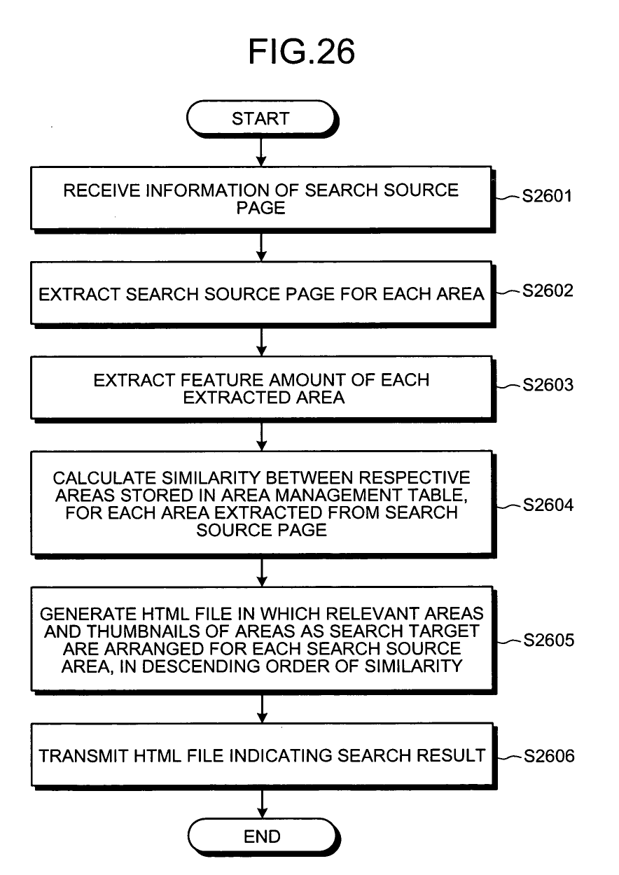

FIG. 26 is a flowchart of a process procedure performed by the document management server 2200 according to the fourth embodiment.

The communication processing unit 102 receives a request to perform a similar page search and information of the search source page (step S2601). According to the fourth embodiment, the communication processing unit 102 receives “unit of display” and “type of area to be displayed” selected by the user on the screen shown in FIG. 24, and the page information together with a request to search for a similar page. In the flowchart, an example in which the selected “unit of display” is the area, and the “type of area to be displayed” is “diagram”, “table”, and “text” is shown. That is, in the flowchart, the similar area is searched for each “diagram”, “table”, and “text” included in the page selected by the user, and an HTML file in which a thumbnail of the searched area is arranged for each “diagram”, “table”, and “text” is generated.

The area extracting unit 106 extracts each area for each type of data included in the search source page (step S2602).

The area-feature extracting unit 108 extracts a feature amount for each extracted area (step S2603). The extracted feature amount is different depending on the type of data for each area.

The similarity-information searching unit 2201 calculates the similarity between respective areas stored in the area management table for each “diagram”, “table”, and “text”, which are the areas extracted from the search source page (step S2604). The similarity can be calculated by comparing the feature amount of the areas with each other. The similarity takes a value of from 0 to 1, and it is determined that the areas are similar when the similarity takes a value of 0.3 or less. The similarity becomes 1 between different types.

The search-result generating unit 2202 generates an HTML file in which the thumbnails of areas determined to have high similarity, of the areas stored in the area management table, are arranged in descending order of similarity for each “diagram”, “table”, and “text” included in the search source page (step S2605).

The communication processing unit 102 transmits the generated HTML file to the PC 150 (step S2606). Accordingly, the PC 150 can display the similar area for each area included in the search source page.

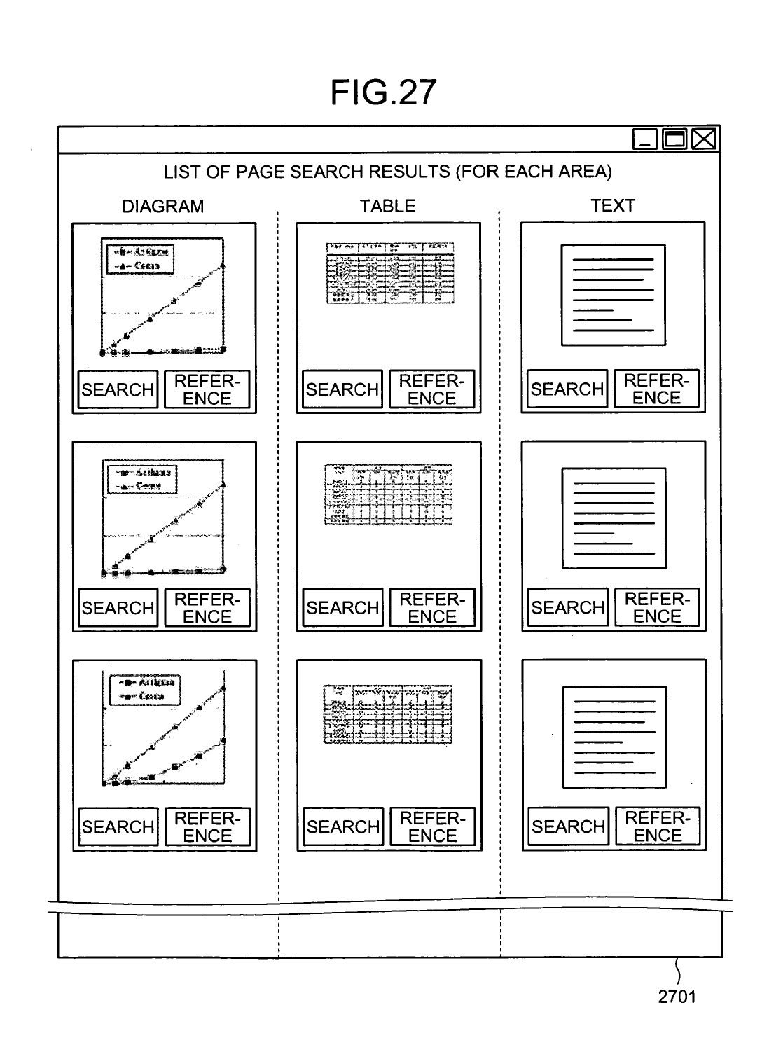

FIG. 27 is a schematic for explaining a screen example in which an HTML file generated by the processing at step S2605 performed by the search-result generating unit 2202 is displayed on the display of the PC 150. As shown in FIG. 27, in a page 2701, thumbnails of the similar areas are arranged for each “diagram”, “table”, and “text”.

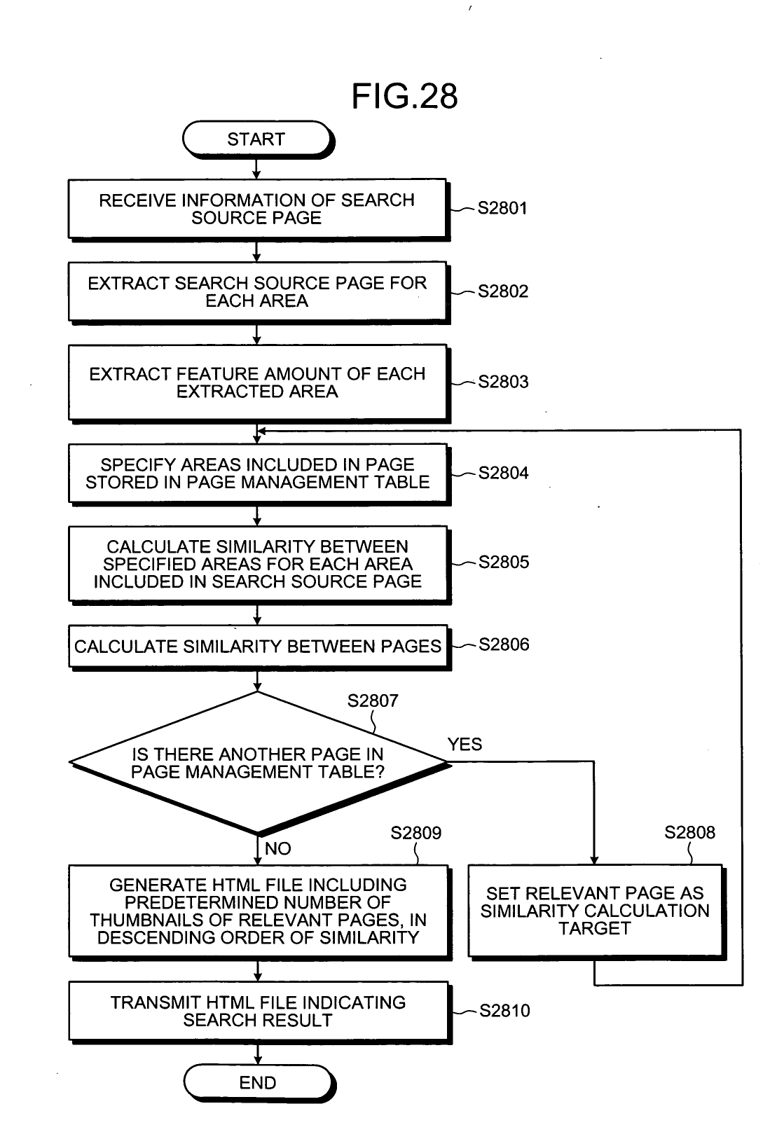

FIG. 28 is a flowchart of a process procedure performed by the document management server 2200 according to the fourth embodiment.

The communication processing unit 102 first receives a request to perform a similar page search and information of the search source page (step S2801). In the flowchart, it is assumed that the selected “unit of display” is a page. That is, in the flowchart, a page similar to the page selected by the user is searched for, to generate an HTML file in which the thumbnails of the pages determined to be similar are arranged in descending order of similarity.

The area extracting unit 106 extracts each area for each type of data included in the search source page (step S2802).

The area-feature extracting unit 108 extracts the feature amount for each extracted area (step S2803). The extracted feature amount is different depending on the type of data for each area.

The area-feature extracting unit 108 re-corrects the image data indicating the respective extracted areas. For example, the image data of the area extracted from the scanned document data is corrected to increase the contrast and improve chroma by color correction. As a result, the image data having a color close to the digital document is created. As a result, because reproducibility of the image data is improved, appropriate similarity can be calculated.

The similarity-information searching unit 2201 sets a page as the search target from the pages stored in the page management table in the document meta-database 1911 to specify an area included in the page (step S2804). The similarity-information searching unit 2201 obtains information (for example, feature amount) of the area included in the page from the area management table in the document meta-database 1911.

The similarity-information searching unit 2201 calculates the similarity between an area in the obtained page as the search target and each area included in the search source page (step S2805).

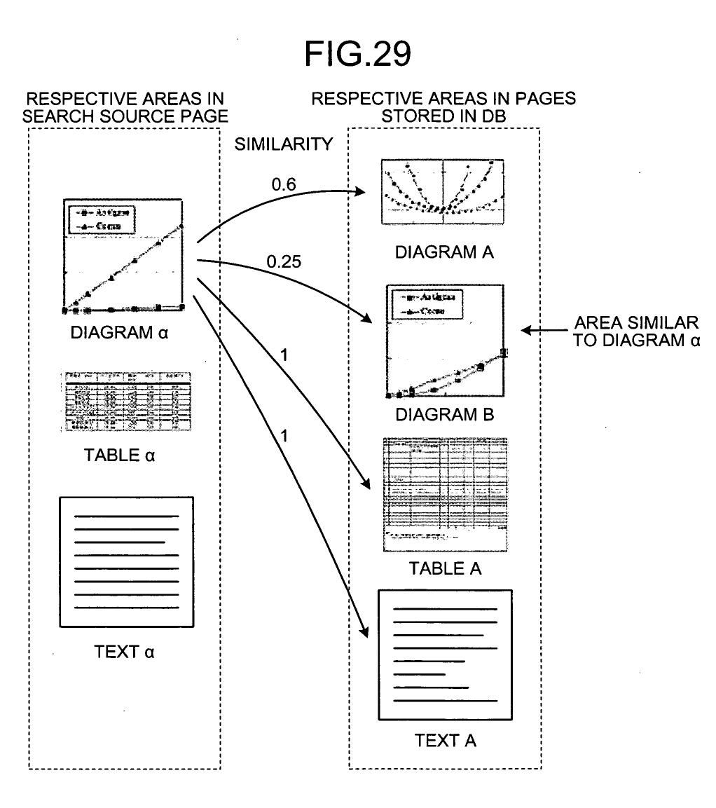

FIG. 29 is a schematic for explaining a concept when the similarity-information searching unit 2201 calculates the similarity. As shown in FIG. 29, the similarity-information searching unit 2201 calculates respective areas included in the respective pages obtained as the search target and the similarity for each area extracted from the search source page. When it is determined that a plurality of text areas is present in the page, the similarity-information searching unit 2201 combines the text areas to form one text area, and then calculates the similarity with the text area.

The similarity takes a value of from 0 to 1, and it is determined that the areas are similar when the similarity takes a value of 0.3 or less. The similarity becomes 1 between different types. The similarity-information searching unit 2201 determines that an area having the lowest similarity of the calculated similarities is similar to the search source area. In the example shown in FIG. 29, the similarity between Diagram α as the search source area and the respective areas in the page obtained from the document meta-database 1911 is calculated, and it is assumed that similarity “0.6” with Diagram A, similarity “0.25” with Diagram B, similarity “1” with Table A, and similarity “1” with Text A are calculated. In this case, the similarity-information searching unit 2201 determines that the area similar to Diagram U is Diagram B, and the similarity between the areas is “0.25”. According to this process, the similarity-information searching unit 2201 performs determination of the similar area and calculation of the similarity between the areas relative to each search source area. When an area of the same type as the search source area is not present in the page as the search target, the similarity-information searching unit 2201 assumes that there is no similar area, and sets the similarity to “1”.

According to the fourth embodiment, the similarity is calculated according to the above process procedure; however, the similarity can be calculated by using another process procedure.

Returning to FIG. 28, the similarity-information searching unit 2201 calculates the similarity between the pages based on the similarity for each area calculated at step S2805 (step S2806). According to the fourth embodiment, the similarity-information searching unit 2201 calculates the similarity between the pages by calculating an average of the similarity of the respective calculated areas. According to the fourth embodiment, the similarity between the pages is not limited to the average value, and another value such as a total value can be used.

The similarity-information searching unit 2201 determines whether there is another page, for which the similarity is not calculated, in the page management table (step S2807).

When determining that there is a page for which the similarity is not calculated (YES at step S2807), the similarity-information searching unit 2201 sets the page as the similarity calculation-target page (step S2808). The similarity-information searching unit 2201 then performs again processing for specifying the similarity included in the page onward (step S2804).

When the similarity-information searching unit 2201 calculates the similarity of all the pages stored in the page management table and determines that there is no page (NO at step S2807), the search-result generating unit 2202 generates an HTML file in which thumbnails of the pages stored in the page management table are arranged in descending order of similarity (step S2809).

The communication processing unit 102 transmits the generated HTML file to the PC 150 (step S2810). As a result, the PC 150 can display the page similar to the search source page.

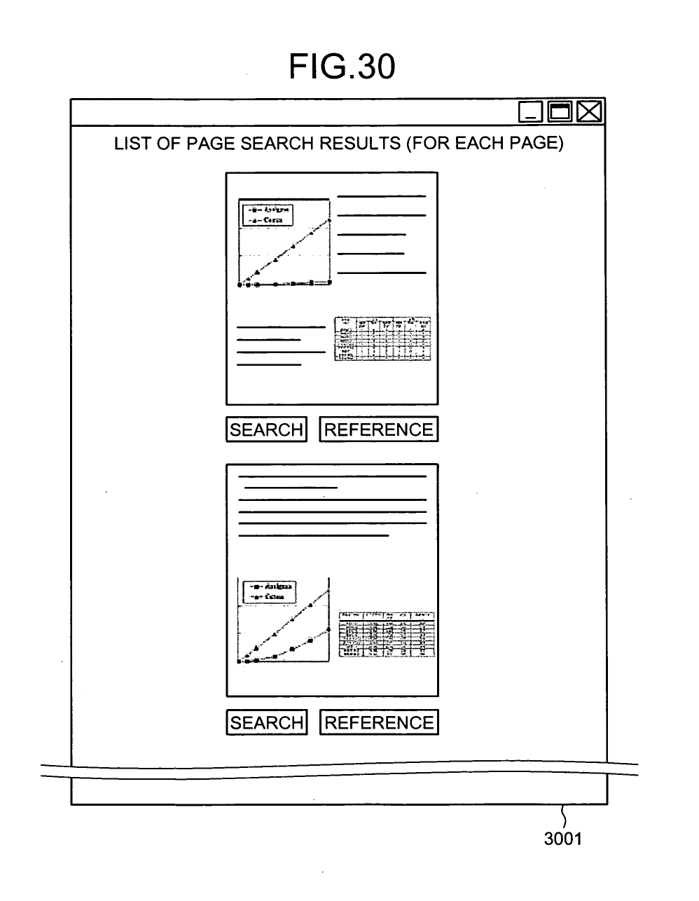

FIG. 30 is a schematic for explaining a screen example in which an HTML file generated by the processing at step S2202 performed by the search-result generating unit 2202 is displayed on the display of the PC 150. As shown in FIG. 30, in a page 3001, thumbnails of pages stored in the document meta-database 1911 are arranged in descending order of similarity.

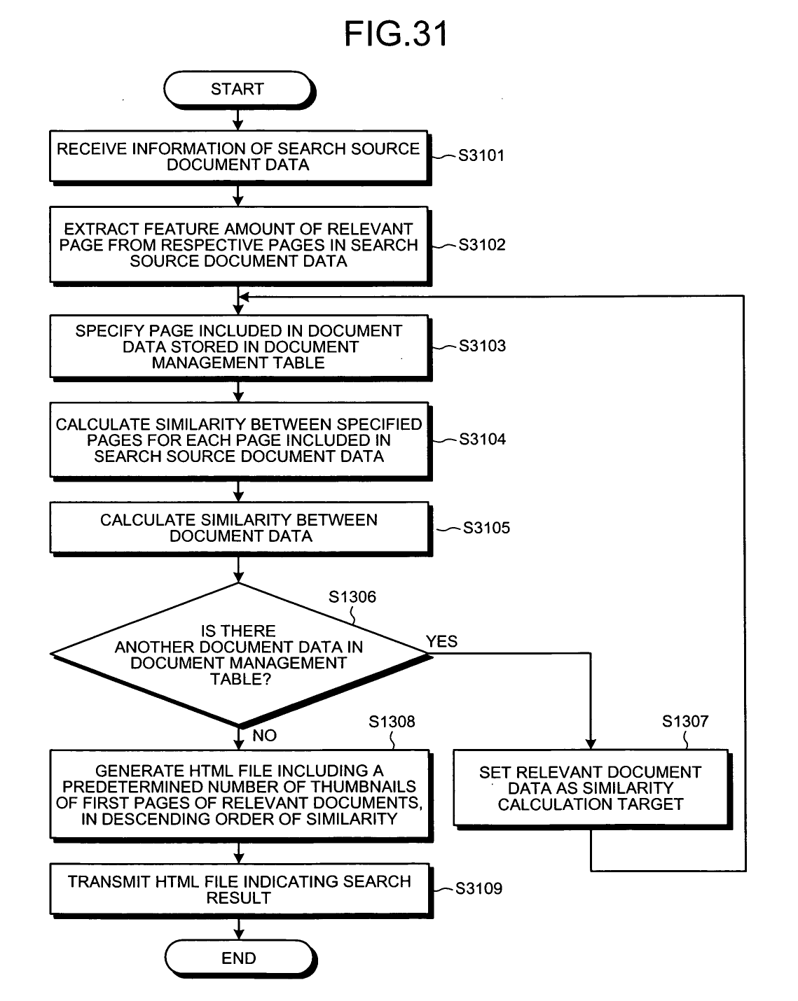

FIG. 31 is a flowchart of a process procedure performed by the document management server 2200 according to the fourth embodiment.

The communication processing unit 102 receives a request to perform a similar document search and information of the search source document (step S3101).

The page feature extracting unit 109 extracts the feature amount of the respective pages included in the search source document (step S3102).

The similarity-information searching unit 2201 sets one document to be searched from the documents stored in the document management table in the document meta-database 1911 to specify a page included in the document (step S3103). The page can be specified by using the document management table and the page management table. The similarity-information searching unit 2201 obtains the information of the page included in the document from the page management table.

The similarity-information searching unit 2201 calculates the similarity between each page included in the search source document and a page in the document obtained as the search target (step S3104).

The similarity is calculated by comparing a feature amount of a page between an optional page in the search source document and respective pages included in the document as the search target. The similarity takes a value of from 0 to 1, and it is determined that the areas are similar when the similarity takes a value of 0.3 or less. The similarity-information searching unit 2201 calculates the similarity for each page and determines that the page having the lowest value is a page similar to the search source page. The similarity-information searching unit 2201 performs this processing for all the search source pages. According to the fourth embodiment, the similarity is calculated by using the feature amount of the page, however, the similarity can be calculated for each area included in the page to calculate the similarity of each page.

The similarity-information searching unit 2201 calculates the similarity between documents based on the similarity of each page (step S3105). According to the fourth embodiment, the similarity-information searching unit 2201 calculates the similarity between the documents by calculating an average of the similarity of respective calculated pages. According to the fourth embodiment, the similarity between the documents is not limited to the average value, and a total value or the like can be used.

The similarity-information searching unit 2201 determines whether there is another document, for which the similarity is not calculated, in the page management table (step S3106).

When determining that there is a document for which the similarity is not calculated (YES at step S3106), the similarity-information searching unit 2201 sets the document as a similarity calculation-target document (step S3107). The similarity-information searching unit 2201 performs again processing for specifying the page included in the document (step S3103).

When the similarity-information searching unit 2201 calculates the similarity of all the documents stored in the document management table and determines that there is no other document (NO at step S3106), the search-result generating unit 2202 generates an HTML file in which thumbnails of the first pages of the documents are arranged in descending order of similarity, among the documents stored in the document management table (step S3108).

The communication processing unit 102 transmits the generated HTML file to the PC 150 (step S3109). As a result, the PC 150 can display the documents similar to the search source document.

In the document management server according to the fourth embodiment, convenience is improved by enabling search of an area similar to the area included in the page, a similar page, and a similar document. Even when the document management server manages a huge amount of document data, the user can easily obtain desired information.

The present invention is not limited to the embodiments described above, and various modifications such as ones exemplified below can be made.

According to the fourth embodiment, when the similar page or area is searched, the search is performed by using a feature amount of the search source page or area as the key. However, the present invention is not limited to such a similarity information search, and searches can be performed by using a feature amount of the page or area detected by a similarity search as a key.

In a modified example 1, a case that a similar page or area is searched by using the feature amount of the page or area detected by the similarity search, to generate an HTML file arranged in a time series order is explained below. Note that the present invention is not limited to perform one step of search using the feature amount of the page or area detected by the similarity search as the key, and search can be recursively performed for several times. Explanations for the same parts as according to the fourth embodiment will be omitted. A tree structure expanding around the search source page or area can be generated by recursively performing the search.

In the modified example 1, when a similar page or area is searched by using a feature amount of a page or area older than the creation/update time of the first search source page or area as the key, the search condition is set so that an area or page created or updated before the creation/update date of the page or area is detected. When the similar page or area is searched by using a feature amount of the page or area latest than the creation/update time of the first search source page or area as the key, the search condition is set so that an area or page created and updated later than the creation/update date of the page or area is detected.

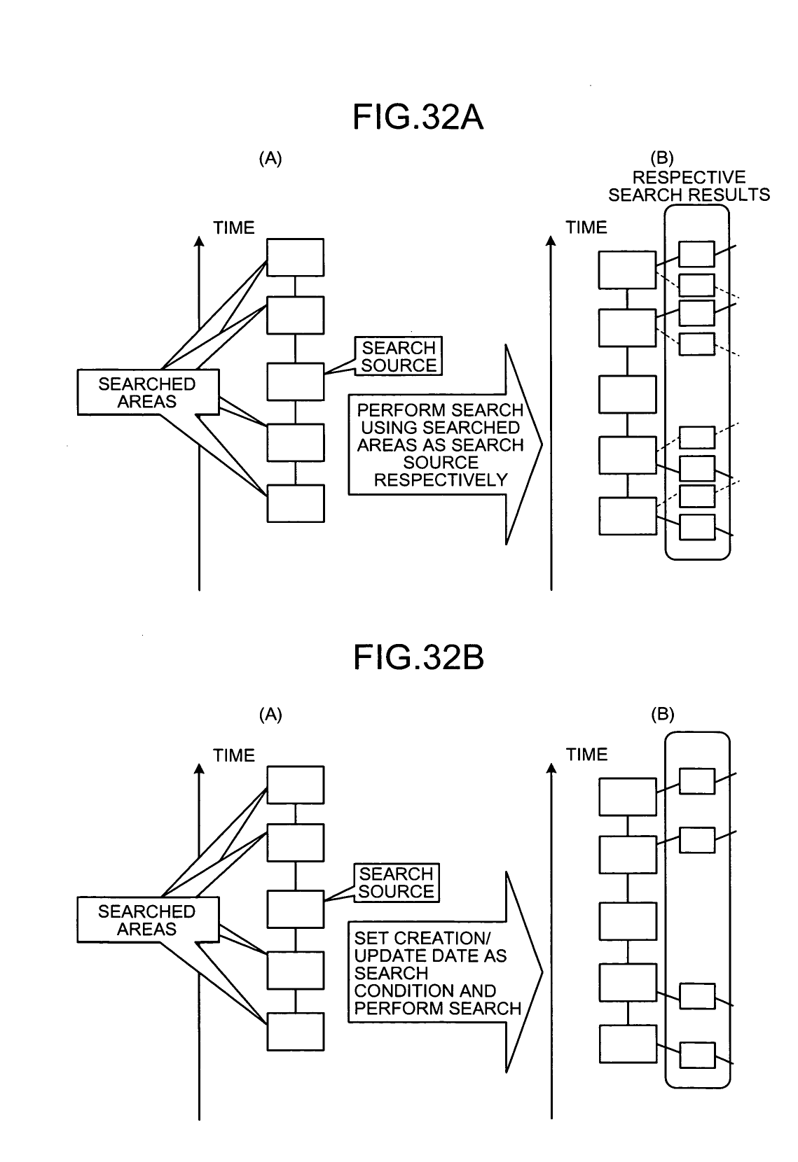

FIG. 32A is a schematic for explaining a tree generated by recursively searching for a similar area at the time of searching for the similar area, as another example of the modified example 1, when a search condition for creation/update date is not set. (A) in FIG. 32A indicates a tree formed of an area detected by the similarity-information searching unit, using the feature amount of the search source area as the key, and the search source area. (B) in FIG. 32A indicates a tree when the similarity-information searching unit performs a search, using the feature amount of the detected areas. Thus, when a condition is not set for the creation/update date, many areas are detected. In this modified example, therefore, the creation/update date is set as the search condition, at the time of recursively searching for a similar area or page. The search condition is as described above.

FIG. 32B is a schematic for explaining a tree generated by recursively searching for a similar area at the time of searching for similar areas in the modified example 1, when a predetermined setting is made as the search condition for the creation/update date. (A) in FIG. 32B is the same as (A) in FIG. 32A, and explanations thereof will be omitted.

(B) shown in FIG. 32B indicates a result of recursive search displayed in a time series chart. This type of display is effective when a history of document images is managed. In other words, when a plurality of users edits one document image, thereby generating a plurality of document images, the history of the document images edited by the users becomes as shown in (B) in FIG. 32B. Thus, the document management server in this modified example can manage the history of the document images edited by a plurality of persons, and can display the history of the document images edited by a plurality of persons so that users can easily understand the history. Such a recursive search can be applied not only to the area and the page, but also to the document.

In the modified example 1, a case that after the similar area or page is recursively searched, an HTML file in which the similar areas or pages are displayed according to a time series is generated has been explained. However, the present invention is not limited to a case that the display in the time-series order is performed after the recursive search is performed.

In a modified example 2, a case that areas detected by the recursive similar search are displayed according to the similarity is explained. Any method can be used as the calculation method of the similarity based on the feature amount, irrespective of known methods.

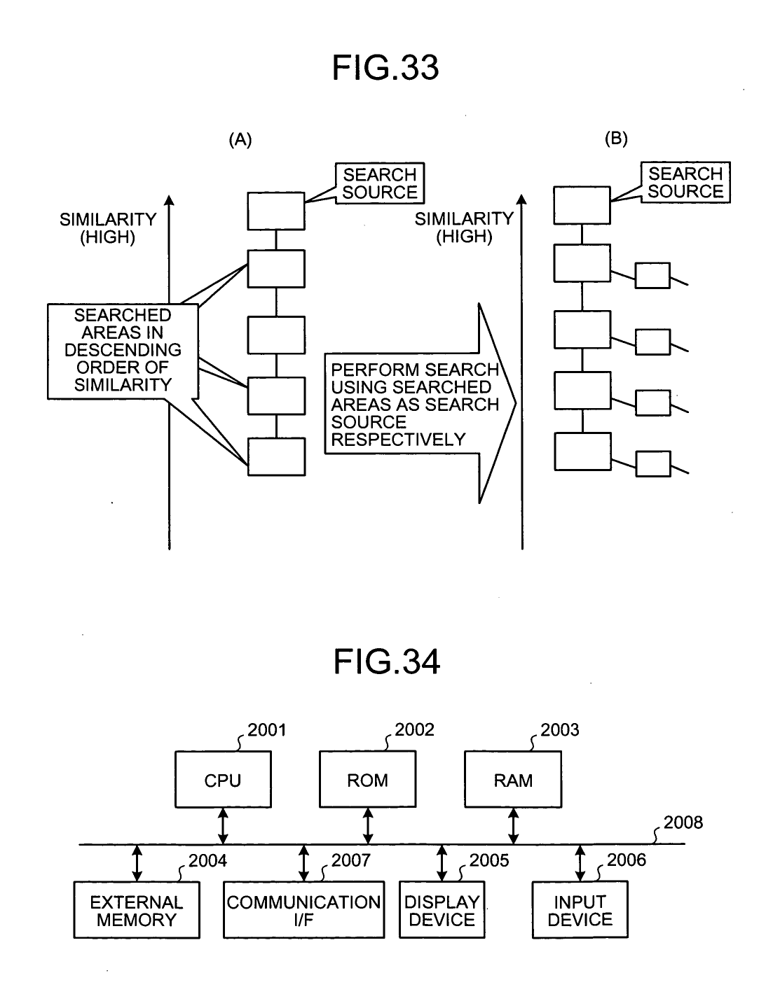

FIG. 33 is a schematic for explaining the tree generated by recursively searching for similar areas at the time of searching for the similar area in the modified example 2. The areas are generated in a tree structure in descending order of similarity to the search source area in (A) in FIG. 33.

The area detected by using the feature amount of the detected area as the key is associated with the search source area in (B) in FIG. 33. The recursively detected areas are also arranged in the order of similarity. The search-result generating unit generates an HTML file as shown in (B) in FIG. 33.

As a specific procedure, when searching for a similar area or page, the similarity-information searching unit according to the modified example 2 obtains the similarity to the search source page or area based on the feature amount. The similarity-information searching unit searches for the similar page or area, using the feature amount of the detected page or area as the key, thereby to obtain the detected similarity and the similarity to the search source. When the similar area is recursively searched, the search source is associated with the detected area. Thus, the search-result generating unit generates an HTML file in which the search source is linked with the detected area or page, even when the similar page or area is recursively searched.

According to the modified example 2, the user can specify the area or page, in which the desired information is described, from the document management server that manages a huge amount of electronic document. Because an HTML file describing a tree in which similar pages or areas are linked with each other is generated, the user can easily understand a relation between objects such as areas or pages.

FIG. 34 is a hardware configuration of the PC executing a program for realizing functions of the document management server. The document management server in this embodiment has a hardware configuration using a normal computer, including a controller such as a central processing unit (CPU) 2001, memories such as a read only memory (ROM) 2002 and a RAM 2003, an external memory 2004 such as a hard disk drive (HDD) or a compact disk (CD) drive, a display device 2005, an input device 2006 such as a keyboard and a mouse, a communication interface 2007, and a bus 2008 for connecting these devices.

The document management program executed by the document management server in this embodiment is recorded on a computer readable recording medium such as a compact disk-read only memory (CD-ROM), a flexible disk (FD), a compact disk-recordable (CD-R), or a digital versatile disk (DVD), in an installable executable format and provided.

The document management program executed by the document management server in this embodiment can be stored on a computer connected to a network such as the Internet, and provided by downloading the program via the network. Further, the document management program executed by the document management server in this embodiment can be provided or distributed via the network such as the Internet.

The document management program in this embodiment can be incorporated beforehand on the ROM or the like and provided.

The document management program executed by the document management server in this embodiment has a module configuration including the respective units described above (the communication processing unit, the searching unit, the similarity-information searching unit, the search-result generating unit, the area extracting unit, the relation extracting unit, the area-feature extracting unit, the page-feature extracting unit, and the registering unit). As actual hardware, the CPU reads the document management program from the storage medium and executes the document management program, thereby to load the respective units on a main memory. As a result, the communication processing unit, the searching unit, the similarity-information searching unit, the search-result generating unit, the area extracting unit, the relation extracting unit, the area-feature extracting unit, the page-feature extracting unit, and the registering unit are generated on the main memory.

As described above, the information management apparatus, the information management method, and the computer program product according to the present invention are suitable as a technique for searching for a page or an area in a document image.

Additional advantages and modifications will readily occur to those skilled in the art. Therefore, embodiments of the invention are not limited to the specific embodiments described herein. Accordingly, various modifications can be made without departing from the spirit or scope of the inventive concept as defined by the appended claims and their equivalents.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for managing information, comprising:
a storage unit that stores therein area correspondence information in which area information included in an area constituting each page of document information is associated with relation information indicating a relation between the document information, the page, and the area information;
an area extracting unit that extracts the area information from the page of the document information for each area of different types arranged on the page;
a relation extracting unit that extracts relation information indicating a relation between the area information extracted by the area extracting unit and the page of the document information that is an extraction source of the area information, from the page of the document information; and
a registering unit that registers the area information extracted by the area extracting unit and the relation information extracted by the relation extracting unit in the area correspondence information in association with each other.

2. The apparatus according to claim 1, further comprising a feature extracting unit that extracts feature information indicating a feature of the area information from the area information extracted by the area extracting unit, wherein
the storage unit stores the feature information in association with the area information and the relation information as the area correspondence information, and
the registering unit registers the area information extracted by the area extracting unit, the relation information extracted by the relation extracting unit, and the feature information extracted by the feature extracting unit in the area correspondence information in association with each other.

3. The apparatus according to claim 2, further comprising a searching unit that searches the area information from the area correspondence information stored in the storage unit.

4. The apparatus according to claim 2, further comprising a similarity-information searching unit that compares the feature information associated with the area information that becomes a search source with the feature information held in the area correspondence information, in the area correspondence information stored in the storage unit, and when a predetermined condition is satisfied, detects the area information associated with held feature information.

5. The apparatus according to claim 1, further comprising a character-information extracting unit that extracts character information indicating a character included in an area displayed based on the area information, from the area information extracted by the area extracting unit, wherein
the storage unit stores the area correspondence information in association with character information, and
the registering unit registers the character information extracted by the character-information extracting unit in association with the area correspondence information.

6. The apparatus according to claim 5, wherein
the storage unit stores position information in the page of image information as the relation information,
the relation extracting unit extracts the position information of the image information included in the area constituting the page of the document information as the extraction source, and
the information management apparatus further comprises a page-information generating unit that generates page information in which the image information stored in the storage unit is arranged according to the position information associated with the image information, and adds the character information in the image information area from which the character information of the page information is extracted.

7. The apparatus according to claim 5, wherein the searching unit searches the character information registered by the registering unit associated with the area correspondence information, using a character string input by a user as a key, and detects the image information associated with the character information matched in the search.

8. The apparatus according to claim 1, wherein
the storage unit stores page correspondence information in which page information indicating a document information page is associated with the document information, and includes the page information as the relation information associated with the area information in the area correspondence information,
the registering unit registers page information indicating the page of the document information and the document information in the page correspondence information stored in the storage unit in association with each other, and also registers the area information, the relation information, and the page information in the area correspondence information in association with each other, and
the information management apparatus further comprises an output processing unit that outputs the area information, and at least one of the document information and the page information specified by the relation information associated with the area information in the area correspondence information stored in the storage unit.

9. The apparatus according to claim 8, further comprising a tree-structure generating unit that generates a tree structure formed with the area information, and the document information and the page information specified by the relation information associated with the area information in the area correspondence information stored in the storage unit, wherein
the output processing unit outputs the document information, the page information, and the area information in the tree structured generated by the tree-structure generating unit, and outputs the document information, the page information, and the area information in an order of time series at which the document information is generated or updated, at the time of outputting a plurality of pieces of document information.

10. A method of managing information, comprising:
area extracting including extracting area information from a page of document information for each area of different types arranged on the page;
relation extracting including extracting relation information indicating a relation between the area information extracted at the area extracting and the page of the document information that is an extraction source of the area information, from the page of the document information; and
registering the area information extracted at the area extracting and the relation information extracted at the relation extracting in area correspondence information stored in a storage unit in association with each other.

11. The method according to claim 10, further comprising feature extracting including extracting feature information indicating a feature of the area information from the area information extracted at the area extracting, wherein
the registering includes registering the area information extracted at the area extracting, the relation information extracted at the relation extracting, and the feature information extracted at the feature extracting in association with each other as the area correspondence information.

12. The method according to claim 11, further comprising searching the area information from the area correspondence information stored in the storage unit.

13. The method according to claim 11, further comprising similarity-information searching including
comparing the feature information associated with the area information as a search source with the feature information held in the area correspondence information, in the area correspondence information stored in the storage unit, and
detecting, when a predetermined condition is satisfied, the area information associated with held feature information.

14. The method according to claim 10, further comprising character-information extracting including extracting character information indicating a character included in an area displayed based on the area information from the area information extracted at the area extracting, wherein
the registering includes registering the character information extracted at the character-information extracting in association with the area correspondence information.

15. The method according to claim 14, wherein the relation extracting includes extracting position information in the page of the image information included in the area constituting a page of document information as the extraction source as information included in the relation information, and
the information management method further comprises page-information generating including
generating page information in which the image information stored in the storage unit is arranged according to the position information in the page included in the relation information associated with the image information, and
adding the character information in the image information area from which the character information of the page information is extracted.

16. The method according to claim 14, the searching includes
searching the character information registered at the registering associated with the area correspondence information, using a character string input by a user as a key, and
detecting the image information associated with the character information matched in the search.

17. The method according to claim 10, wherein
the storage unit stores therein page correspondence information in which page information indicating a page of document information is associated with the document information, and includes the page information as the relation information associated with the area information in the area correspondence information,
the registering includes
registering page information indicating the page of the document information and the document information as the page correspondence information in the storage unit in association with each other, and
registering the area information, the relation information, and the page information in the area correspondence information in association with each other, and
the information management method further comprises output processing including outputting the area information, and at least one of the document information and the page information specified by the relation information associated with the area information in the area correspondence information stored in the storage unit.

18. The method according to claim 17, further comprising generating a tree structure formed with the area information, and the document information and the page information specified by the relation information associated with the area information in the area correspondence information stored in the storage unit, wherein
the output processing includes
outputting the document information, the page information, and the area information in the tree structured generated at the generating, and
outputting the document information, the page information, and the area information in an order of time series at which the document information is generated or updated, at the time of outputting a plurality of pieces of document information.

19. A computer program product comprising a computer usable medium having computer-readable program codes embodied in the medium that when executed cause a computer to execute:
area extracting including extracting area information from a page of document information for each area of different types arranged on the page;
relation extracting including extracting relation information indicating a relation between the area information extracted at the area extracting and the page of the document information that is an extraction source of the area information, from the page of the document information; and
registering the area information extracted at the area extracting and the relation information extracted at the relation extracting in area correspondence information stored in a storage unit in association with each other.

20. The computer program product according to claim 19, wherein
the area extracting includes extracting the area information from the page of document information for each area of different types arranged on the page,
the computer-readable program codes further causes the computer to execute character-information extracting including extracting character information indicating a character included in an area displayed based on the area information from the area information extracted at the area extracting,
the registering includes registering the character information extracted at the character-information extracting in association with the area correspondence information, and
the computer-readable program codes further causes the computer to execute searching the character information registered in the area correspondence information stored in the storage unit, using a character string input by a user as a key, at the time of searching the image information, to acquire the image information associated with the searched character information.
